(19) United States
(12) Patent Application Publication
(10) Pub. No.: US 2024/0382846 A1
(43) Pub. Date: Nov. 21, 2024

(54) METHOD AND APPARATUS FOR FACILITATING VISUAL ILLUSTRATIONS ALONG RAILS OF A BATTLE FIELD VIA A COMPUTER SIMULATION

(71) Applicant: MEDIA ALLIANCE GAMING STUDIO Sp.zo.o., Regon (PL)

(72) Inventor: Hannah Grace Larson, Elbe, WA (US)

(21) Appl. No.: 18/317,819

(22) Filed: May 15, 2023

(51) Int. Cl. A63F 13/47

(52) U.S. Cl. CPC A63F 13/47; A63F 2300/8076

(57) ABSTRACT

A video game and/or interactive gaming process emulating one or more battles based on some historical events using a resource confined simulation (“RCS”) system is disclosed. Upon simulation of a rail containing conflicting nodes emulating a theater in accordance with some recorded historical facts, the process of RCS facilitates a user traveling on the rail approaching to a conflicting node. Upon receiving an inquiry of Xmap selection for visual illustration of possible story-line based on the rail, another rail, and/or user inputs, multiple moving tiles containing visual illustrations are generated in response to current images of rails via conversion of graphic elements to Xmap elements. The process subsequently projects or displays one of visual moving tiles based on the inquiry of Xmap election.

### FIELD

The exemplary embodiment(s) of the present invention relates to the field of computer hardware and software. More specifically, the exemplary embodiment(s) of the present invention relates to computer simulation or video games.

### BACKGROUND

Video games and/or interactive real-time computing-based games are generally played on various types of electronic systems. For example, systems can be connected by a network such as Internet for real-time interactive playing. Typical electronic systems which can host video games or interactive games include laptop computers, smartphones, tablets, desktop computers, handheld portable devices, and/or video game consoles, such as PlayStation 4, Xbox One, and/or Nintendo Switch. The hardware and/or software capable of hosting conventional video games is typically relating to fictitious stories with unlimited resources.

A drawback associated with a conventional video game operated by a typical electronic system is that it generally lacks values such as historical, educational, and/or teaching values.

### SUMMARY

A video game and/or interactive gaming process emulating one or more battles based on some historical events using a resource confined simulation (“RCS”) system is disclosed. Upon simulation of a rail containing conflicting nodes emulating a theater in accordance with some recorded historical facts, the process of RCS facilitates a user traveling on the rail approaching to a conflicting node. Upon receiving an inquiry of Xmap selection for visual illustration of possible story-line based on the rail, another rail, and/or user inputs, multiple moving tiles containing visual illustrations are generated in response to current images of rails via conversion of graphic elements to Xmap elements. The process subsequently projects or displays one of visual moving tiles based on the inquiry of Xmap election.

Additional features and benefits of the exemplary embodiment(s) of the present invention will become apparent from the detailed description, figures and claims set forth below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating a resource confined simulation (“RCS”) system for emulating a sequence of events using Xmap in accordance with at least in part on the historical events in accordance with one or more embodiments of the present invention;

FIG. 2 is a block diagram illustrating a detailed database builder and database which can be accessed by Xmap in accordance with one or more embodiments of the present invention;

FIG. 3 is a logic block diagram illustrating an exemplary process of emulating RCS in accordance with established parameters in accordance with one or more embodiments of the present invention;

FIG. 4 is a logic block diagram illustrating an alternative logic flow for emulating RCS in accordance with one or more embodiments of the present invention;

FIG. 5 is an event tree diagram illustrating an exemplary rail tree containing multiple rails for emulating RCS in accordance with one or more embodiments of the present invention;

FIG. 6 is a block diagram illustrating a rail tree containing multiple rails and nodes in a theater emulated via RCS in accordance with one or more embodiments of the present invention;

FIG. 7 is a logic block diagram illustrating a process of moving or progressing a player between nodes on a rail emulating by RCS in accordance with one or more embodiments of the present invention;

FIG. 8 is a block diagram illustrating an exemplary logic process progressing between nodes on one or more rails via RCS in accordance with one or more embodiments of the present invention;

FIG. 9 is a flowchart illustrating an exemplary process of RCS emulating a player's progress or movement between nodes on a rail in accordance with one embodiment of the present invention;

FIG. 10 is a flowchart illustrating an exemplary process of RCS emulating symbols superimposed over a map showing movements between nodes on a rail in accordance with one embodiment of the present invention;

FIGS. 11A-11C are maps containing geographic terrains illustrating a battle field using symbols superimposed over the map showing a node on a rail in accordance with one embodiment of the present invention;

FIG. 12 is a block diagram illustrating a logic process of Xmap used to facilitate visual illustration relating to maps and/or illustrations of a battle in accordance with one or more embodiments of the present invention;

FIG. 13 is a flowchart illustrating an exemplary process of Xmap facilitated by RCS in accordance with one embodiment of the present invention;

FIG. 14 is a block diagram showing a visual illustration or map facilitated by Xmap relating to object preparation simulated by RCS system in accordance with one or more embodiments of the present invention;

FIG. 15 is a flowchart illustrating an exemplary process of Xmap simulated by the RCS system capable of emulating an object preparation in accordance with one embodiment of the present invention;

FIG. 16 is a block diagram illustrating a process of battle mode using Xmap facilitated by RCS in accordance with one or more embodiments of the present invention;

FIG. 17A is a block diagram illustrating a process of skirmish mode using Xmap facilitated by RCS in accordance with one or more embodiments of the present invention;

FIG. 17B is a block diagram illustrating an illustration showing prisoners using Xmap facilitated by RCS in accordance with one or more embodiments of the present invention; and

FIG. 18 is a block diagram illustrating a digital processing system capable of being configured to be the RCS system, database builder, and/or Xmap, in accordance with one or more embodiments of the present invention.

### DETAILED DESCRIPTION

Embodiments of the present invention are described herein with context of a method and/or apparatus for facilitating resource confined simulation (“RCS”) such as computer games, video games, and/or educational program based on certain historical background and/or events.

The purpose of the following detailed description is to provide an understanding of one or more embodiments of the present invention. Those of ordinary skills in the art will realize that the following detailed description is illustrative only and is not intended to be in any way limiting. Other embodiments will readily suggest themselves to such skilled persons having the benefit of this disclosure and/or description.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application—and business-related constraints, and that these specific goals will vary from one implementation to another and from one developer to another. Moreover, it will be understood that such a development effort might be complex and time-consuming, but would nevertheless be a routine undertaking of engineering for those of ordinary skills in the art having the benefit of embodiment(s) of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method. The same reference indicators will be used throughout the drawings and the following detailed description to refer to the same or like parts.

In accordance with the embodiment(s) of present invention, the components, process steps, and/or data structures described herein may be implemented using various types of operating systems, computing platforms, computer programs, and/or general-purpose machines. In addition, those of ordinary skills in the art will recognize that devices of a less general-purpose nature, such as hardware devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

The term “system” or “device” is used generically herein to describe any number of components, elements, sub-systems, devices, packet switch elements, packet switches, access switches, routers, networks, computer and/or communication devices or mechanisms, or combinations of components thereof. The term “computer” includes a processor, memory, and buses capable of executing instruction wherein the computer refers to one or a cluster of computers, personal computers, workstations, mainframes, or combinations of computers thereof.

A process or RCS system capable of emulating RCS also be referred to as a video game(s) or computer game(s) is presented. The RCS system can be a user interactive simulation-based system using at least a portion of historical event via a communications network. The RCS system, which includes a digital processor, memory, and network communication transceiver, is able to establish a historical based information system for emulating RCS. After identifying a historical event in accordance with recorded historical facts for creating an environment to simulate an RCS, the RCS system generates a map as a geographic parameter associated with the RCS in accordance with historical geography relating to the historical event. Upon generating armed force as a military parameter associated with the RCS in accordance with the historical event, a map storage is used to store the map related parameters and an armed force storage for storing the armed force related parameters. The RCS system is able to emulate the RCS in response to various parameters such as the map, armed force, and/or the user input.

The presently claimed embodiment discloses an electronic video game system using RCS to simulate historical battle fields according to in part various historical facts. The system simulates rails containing multiple conflicting nodes or events during a historical theater. A rail containing multiple nodes is a simulation process facilitating a player to walk (or fight) through a sequence of battles based on in part historical events. A sequence of battles is emulated via a rail with multiple nodes wherein the nodes represent battles. A node on a rail represents one or more conflicting events based on the historical facts. After facilitating a user or player traveling on a rail approaching to a node, the system obtains a set of variables having corresponding values in a variable backpack which is designated to the user or player. Upon activating a computational module for calculating updated or modified values of variables, a set of rules designated to the upcoming node is fetched from a rule database. The player or user is then offered an opportunity to change or reenforce the player's fighting capabilities based on the movement of other players' forces and their resources.

One embodiment of video game system provides an interactive gaming process emulating one or more battles based on some historical events using an RCS system. Upon simulation of a rail containing conflicting nodes emulating a theater in accordance with some recorded historical facts, the process of RCS facilitates a user traveling on the rail approaching to a conflicting node. Upon receiving an inquiry of Xmap selection for visual illustration of possible story-line based on the rail, another rail, and/or user inputs, multiple moving tiles containing visual illustrations are generated in response to current images of rails via conversion of graphic elements to Xmap elements. The process subsequently projects or displays one of visual moving tiles based on the inquiry of Xmap election.

### Resource Confine Simulation (“RCS”) System

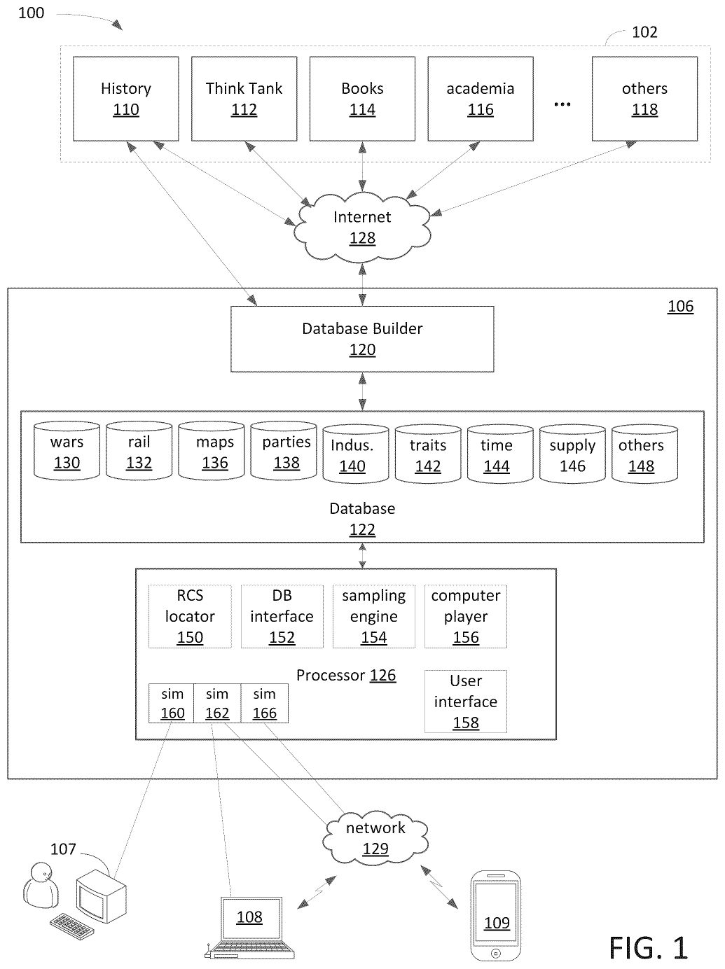

FIG. 1 is a block diagram 100 illustrating an RCS system for emulating a sequence of events using Xmap in accordance with at least in part on the historical events in accordance with one or more embodiments of the present invention. Diagram 100 includes input data 102, RCS system 106, and users 107-109. In one aspect, diagram 100 also includes communications networks 128-129 used for coupling input data 102, RCS system 106, and users 107-109. It should be noted that the underlying concept of the exemplary embodiment(s) of the present invention would not change if one or more blocks (or networks) were added to or removed from diagram 100.

Input data 102, in one embodiment, provides data or information for building a database such as database 122 which will be used to emulate RCS. Input data 102, in one aspect, includes historical data 110, data from think tank 112, recordings from books 114, information from academia 116, and others 118 wherein historical data 110, for example, records or recounts various historical facts and/or events. Such historical data 110 can be generated by historians, museum records, scholars' papers, peoples' recollections from both sides, and the like. In one aspect, historical data 110 is used to emulate an actual historical event(s) during RCS.

Information and/or data from thank tank or foundations 112 can also be part of input data 102 for establishing the database such database 122 for simulation. For example, think tank 112 such as Hoover Institution or Brookings Institution generates think-tank data including, but not limited to, various opinions, geopolitics, and/or predications based on the historical and/or geopolitical data at the time of the event. It should be noted that the think-tank data can also be used to project or predict alternative outcomes instead of actual historical outcomes during hosting of RCS.

Book information 114 includes data from memoirs, documentary movies, articles, and/or books. For example, book information 114 can include recounting of historical events, hypothetical results, or predications of alternative outcomes. In one aspect, book information 114 can be used for both actual historical simulation and alternative simulation for RCS.

Academia studies or papers 116, such as university thesis, essay, dissertation, and/or treatise, can also be used as input data 102. For example, academia papers 116 can be used to refine historical facts, hypothetical alternative outcomes, or missing facts. In one aspect, academia papers 116 can be used for both actual historical simulation and alternative possible outcomes. It should be noted that other information or data such as race, culture, tradition, public sentiment, and/or resolutions from the United Nations, can also be used as input data 102 for emulating RCS.

RCS system 106, in one embodiment, includes a database builder 120, database 122, and processor 126. Database 120 is configured to establish database 122 based on input information 102 for facilitating RCS. Processor 126 is used to facilitate RCS based on parameters stored in database 122 as well as the user inputs. While database builder 120 is responsible to build database 122 from input data 102 via a communications network such as Internet 128, processor 126 employs multiple simulators 160-166 used for interfacing with users 107-109.

Database builder 120, in one embodiment, employs a preloading method, dynamic loading method, or a combination of preloading and dynamic loading method. The preloading method, for example, is a process of building database 122 before an RCS can be simulated. After building of database 122, a user such as user 107 can activate the RCS for simulation. It should be noted that the building process can be automatic based on RCS and the data stored in database 122 using various processes, such as artificial intelligence (“AI”), machine learning (“ML”), manual input, and/or a combination of AI, ML, and manual input.

Alternatively, the dynamic loading, also known as on-demand data building, is a method which is used by database builder 120 or establish necessary data or parameters from a cloud-based RCS network in real-time. For example, upon recognizing that the selected RCS contains no or insufficient data or parameters, database builder 120 is able to search and download necessary information or data to start the selected RCS. Depending on the user input(s), database builder 120 can dynamically build necessary database or parameter to facilitate the selected RCS.

The method of both preloading and dynamic loading can be implemented for certain RCSs. A benefit of using dynamic loading or the combination of preloading and dynamic loading is to save storage space and update the latest information while emulating RCS.

Database 122, in one embodiment, stores various types of data and/or parameters, such as, but not limited to, wars 130, rails 132, maps 136, parties or contries 138, industrial capacity 140, culture traits 142, time duration 144, supply/transportation capabilities 146, and/or others 148. Database 122 can be divided or organized into multiple sub-storage sections such as tables or blocks for storing data 130-148. Depending on the applications and/or RCSs, database 122 can store additional information, such as total population, public sentiment/opinions, world sentiment/opinions, armed force, international supports, and the like. In one example, database 122 can be further organized to store detailed information, such as battalions of armed force, number of warships, number of warplanes, number of tanks, artillery pieces, missiles, chemical weapons, and the like. A function of database 122 is to provide data or information as parameters to processor 126 for facilitating outcome calculation(s).

Processor 126 includes an RCS locator 150, database interface 152, sampling engine(s) 154, computer player 156, user interface 158, and user simulators 160-166. It should be noted that it does not change the scope of processor 126 if additional circuitry or blocks are added or removed. While DB interface 152 is used to communicate with database 122, user interface 158 is used to communicate with users 107-109 via user simulators 160-166. A function of processor 126 is to emulate RCS which can also be referred to as video game(s) and/or interactive war education(s) to produce intermediary or final outcome(s). To simplify forgoing discussion, the term “RCS” will be used in place of video games and/or interactive war educations.

RCS locator 150, in one embodiment, is used to identify one of many simulations or games to play based on the user input. For example, a user such as user 107 can enter a selection of an RCS to play via user simulator 160. Based on user's selection, RCS locator 150 searches through database 122 to locate or identify whether such game or RCS is in the database. Upon allocating the RCS, RCS locator 150, in one aspect, informs processor 126 that the RCS is identified and located. Before activating the selected RCS or game, processor 126 initializes various storage locations and/or tables to load necessary parameters from database 122 for starting to emulate RCS. For example, upon detecting a user input of user 107 selecting RCS of 1973 Middle-East war, RCS locator 150 searches database 122 to identify any data related to 1973 Middle-East war, Yom Kippur War, Ramadan War, October War or the 1973 Arab-Israeli War. Upon verifying that the data is available for selected RCS, processor 126 begins to emulate Yom Kippur War based on the identified data.

Sampling engine 154, in one embodiment, is an RCS engine using one or more statistic algorithms such as Monte Carlo's methods to calculate a battle result or outcome. For example, sampling engine 154 is capable of calculating one or more outcomes based on parameters loaded from database 122. A function of sampling engine 154 is to calculate or project an outcome based on user input(s) as well as various parameters, such as strength of armed force, warplanes, warships, missiles, tanks, supply lines, and the like. Note that Monte Carlo's method is an algorithm using repeated random sampling to obtain numerical results in light of optimization, numerical integration, and probability distribution.

User interface 158 facilitates communication between user simulators 160-166 with processor 126. User simulators 160-166 are used to communicate with users via direct connection such as between user 107 and user simulator 160. Also, user simulators can communicate with users 108-109 via network 129. Depending on the applications, user simulator 162 can connect to user directly or indirectly via a network 129. A function of user simulators such as simulator 160 is to provide an interface between RCS system 106 and users 107-109.

Users 107-109, in one example, can be persons, players, machines, servers, institutions, military trainees, law enforcement trainees, and the like. In one aspect, user such as user 107 is required to enter selections to progress the selected RCS. User can either play RCS with another user or with computer player 156. Note that two remotely situated users can play with each other via a communications network such as network 129.

In one embodiment, RCS system 106 includes user controllers such as user simulators 160-166, a map database such as maps 136, an armed force database such as parties 138, and a digital processor such as processor 126 for facilitating RCS based on at least a portion of the historical events. The user controllers, for example, is able to receive user inputs via one or more user connected consoles for simulating RCS. While the map database stores a map representing a geography associated with the RCS in accordance with historical geography relating to an actual event, the armed force database stores the armed force as a military parameter associated with the RCS in accordance with the historical data. The digital processor generates numerical results or outcomes based on repeated random sampling. Note that the digital processor such as RCS system 106 is able to emulate RCS utilizing numerical or intermediary results in response to the map, armed force, and user input. In one aspect, database 122 includes a party database configured to store data relating to a party involved in the historical event. In one example, RCS system 106 provides a culture characteristic database configured to store data relating to a culture trait based on the historical event. To emulate the RCS, a rail database stores a set of logic flow sequences wherein one of the sequences represents a historic rail and another portion of the sequences may represent another optional rail. A rail includes a set of multiple sequential blocks or events wherein the events are happened in a sequential order according to a time domain. A database controller such as database builder 120 is able to obtain and establish a set of data streams based on at least a portion of the historical events for facilitating RCS.

An advantage of employing RCS system is that it can provide educational teaching as well as entertainment. In addition, RCS system can also predict alternative likely outcomes had certain facts altered.

Another advantage of using Xmap together with RCS system is to allow generating and presenting video and/or graphic illustrations relating to the video games.

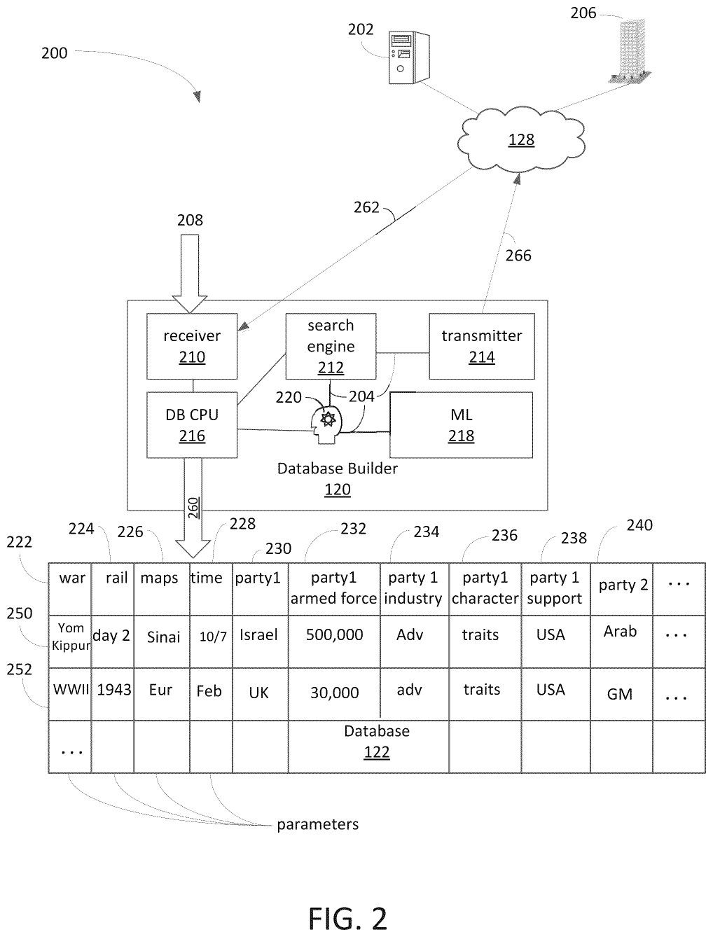

FIG. 2 is a block diagram 200 illustrating a detailed database builder and database which can be accessed by Xmap in accordance with one or more embodiments of the present invention. Diagram 200 includes database builder 120, database 122, remote server 202, remote content provider 206, and Internet 128. Database builder 120 further includes a receiver 210, search engine 212, transmitter 214, AI component 220, ML component 218, and DB CPU 216. It should be noted that the underlying concept of the exemplary embodiment(s) of the present invention would not change if one or more blocks (or networks) were added to or removed from diagram 200.

A function of database builder 120 is to build a database 122 to support emulation of RCS. Builder 120, in one embodiment, employs a preloading method in which receiver 210 obtains data and/or information either from a manual input 208 or network input via Internet 128 as indicated by numeral 262. The preloading method facilitates establishing database 122 before RCS can be emulated. Depending on the applications, DB CPU (central processing unit) 216 builds database 122 via internal bus 260 in accordance with data from receiver 210. To build database 122, the preloading method can also use AI 220 which manages search engine 212 and transmitter 214 via internal connections 204 to search and obtain relevant information from server 202 and/or content provider 206 via Internet 128. ML 218 is subsequently activated to learn and refine searching capabilities based on obtained data in light of RCS. For instance, the preloading method can use both manual input 208 and IA input to build and verify information stored in data base 122.

Database builder 120 can also be configured to perform a method of dynamic loading, also known as on-demand data building, wherein database 122 stores basic data, parameters, or tables when an RCS begins. DB CPU 216 activates AI 220 to obtain necessary data or parameters from a cloud-based RCS network in real-time wherein the necessary data or parameters contain sufficient information for the current and the next turn or move of RCS based on user input. For example, upon recognizing that the selected RCS contains insufficient data or parameters, database builder 120 is able to search and download necessary information or data from the cloud-based RCS network whereby the necessary data will enable to start of selected RCS. Upon modification of search terms by ML 218, transmitter 214, for example, transmits the modified search terms to the cloud-based RCS network via Internet 128. Once the data is obtained and verified by ML 218 and/or AI 220, database 122 is updated accordingly to facilitate the next turn of RCS. The term “turn” or “next move” refers to the process of RCS moving from one phase (block or event) to next phase (block or event) within a rail. A benefit of employ the dynamic loading method for database builder 120 is to provide more RCSs or games with the minimal requirement of local storage capacity.

Database 122, in one embodiment, stores various types of data and/or parameters for multiple RCSs. For example, database 122 stores information or parameters relating to wars 222, rails 224, maps 226, time 228, party 1 or country 1 230, armed force 232, industrial capacity 234, characters or culture traits 236, support 238, party2 230, and the like. Database 122 includes various wars or war theaters such as Yom Kippur 250 and/or WW II (World War Two) 252. For example, war of Yom Kippur 250 has rail parameter of day 2, map parameter of Sinai, time parameter of Oct. 7, 1973, party 1 parameter of Israel, armed force parameter for party 1 is 500,000, party 1 industry parameter of advanced, party 1 character parameter of trait 1, party 1 support parameter of USA, party2 of Arab countries, and the like. In one aspect, database 122 can store additional information, such as, but not limited to, total population, public sentiment/opinions, world opinions/resolutions, international supports, battalions of arm, warships, warplanes, tanks, artillery pieces, missiles, chemical weapons, and the like. A function of database 122 is to provide data or information as parameters to facilitate RCS such as Yom Kippur War day 2.

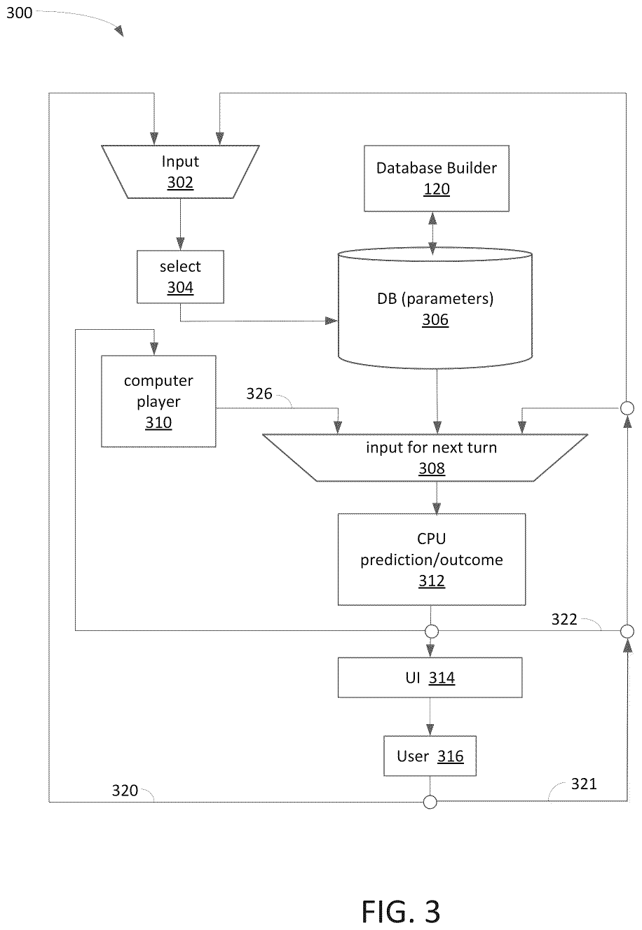

FIG. 3 is a logic block diagram 300 illustrating an exemplary process of emulating an RCS in accordance with established parameters in accordance with one or more embodiments of the present invention. Diagram 300 includes a database builder 120, DB 306, CPU 312, and user 316. Database builder 120, in one example, generates objects that are predefined by the nature of RCS and stored in DB 306 as parameter(s). For instance, if RCS is WWII, time duration parameter is predefined to between 1939 to 1945. It should be noted that the underlying concept of the exemplary embodiment(s) of the present invention would not change if one or more blocks (or networks) were added to or removed from diagram 300.

To initiate a selected RCS, user 316 is usually required to enter a set of players defined objects as indicated by numeral 320. For example, user 316 can select USA as a party 1 parameter. After receipt of user input at input device 302, select module 304 identifies and stores user or player defined objects at DB 306 as parameters. Upon receiving inputs from user input 321, parameters from DB 306, and selections from computer player 310, input component 308 processes and passes processed inputs to CPU 312 for calculation. CPU 312, which provides action spontaneous random processing, initiates and processes game events autonomously using algorithms such as Monte Carlo method without players' input.

UI 324 is used to communicate with user 316. For example, UI 324 can be a computer terminal, computer monitor, smart phone, and/or portable pad capable of providing interface between user 316 and CPU 312. In one aspect, CPU 312 outputs an outcome based on the input parameters. In one aspect, CPU 312 is capable of providing automatic time passage which can be automatically timed or turned based on a predefined time duration.

The RCS system, in one embodiment, is able to create a game that is historically accurate and follows the actual historical events. For example, the RCS system provides computer simulation of historical war processes. To provide an RCS, various mathematical algorithms are used to calculate the chances of winning one or more battles based on a range of input parameters like, number of soldiers on both sides, level of training, morale, supply levels of ammunition and gasoline, surprise level, et cetera. To visualize a war theater, a set of interactive maps are used to reflect the progress of the game.

In one example, a battle algorithm uses at least partially Monte Carlo algorithm with a series of lookup tables for reading values or parameters and plots curves showing war theater. The curves represent relationship between various parts of parameters. For example, curves showing duration of a battle can be a function of ratio between two forces involved. The RCS further includes a large number of scenarios which can be described as “alternative history” scenarios which can be hypothetical possibilities that could change the historical events. For example, if a preemptive strike was initiated, the outcome of Yom Kippur war could be different.

An advantage of using an RCS system is that it presents a historical event or events that had happened. Another advantage is that the RCS system can be teaching tool or predicting tools to provide past, current, and future predictions based on the parameters.

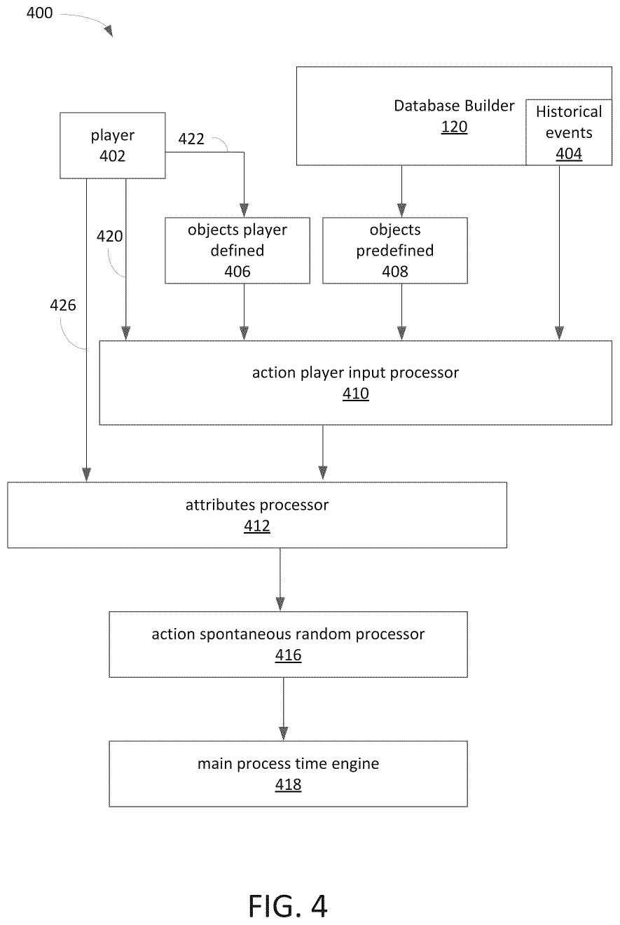

FIG. 4 is a logic block diagram 400 illustrating an alternative logic flow for emulating RCS in accordance with one or more embodiments of the present invention. Diagram 400 includes database builder 120, action player input processor 410, attributes processor 412, and player 402. Database builder 120, in one example, includes historical events and objects that are predefined for one or more RCSs. For instance, if a selected RCS is the second day of Yom Kippur war, time parameter which is predefined to be Oct. 7, 1973 is identified and fetched. It should be noted that the underlying concept of the exemplary embodiment(s) of the present invention would not change if one or more blocks (or networks) were added to or removed from diagram 400.

Player 402, also known as user, initiates an RCS as indicated by numeral 420 and enters a set of player-defined objects as indicated by numeral 422. After receipt of player 402 request for initiating the RCS, action player input processor 410 input obtains historical data or events 404 as simulation parameters from database builder 120. Upon obtaining player-defined objects 406 and objects predefined 408 from database builder 120, action player input processor 410 processes and forwards received data or parameters to attributes processor 412. Based on player or user input 426, attributes processor 412 processes and provides various processed parameters to action spontaneous random processor 416 in accordance player input 426, historical events 404, identified objects 406-408, and the like.

Action spontaneous random processor 416 initiates and processes game events autonomously using algorithms such as Monte Carlo method with or without players' input. After generating an outcome based on various processed parameters, the outcome is subsequently displayed to and/or communicated with player 402. After generating the outcome(s), the process proceeds to main process time engine 418. Depending on the applications and player's input(s), main process time engine 418 maintains and controls logic flow of the RCS or game.

### Building Rail Tree

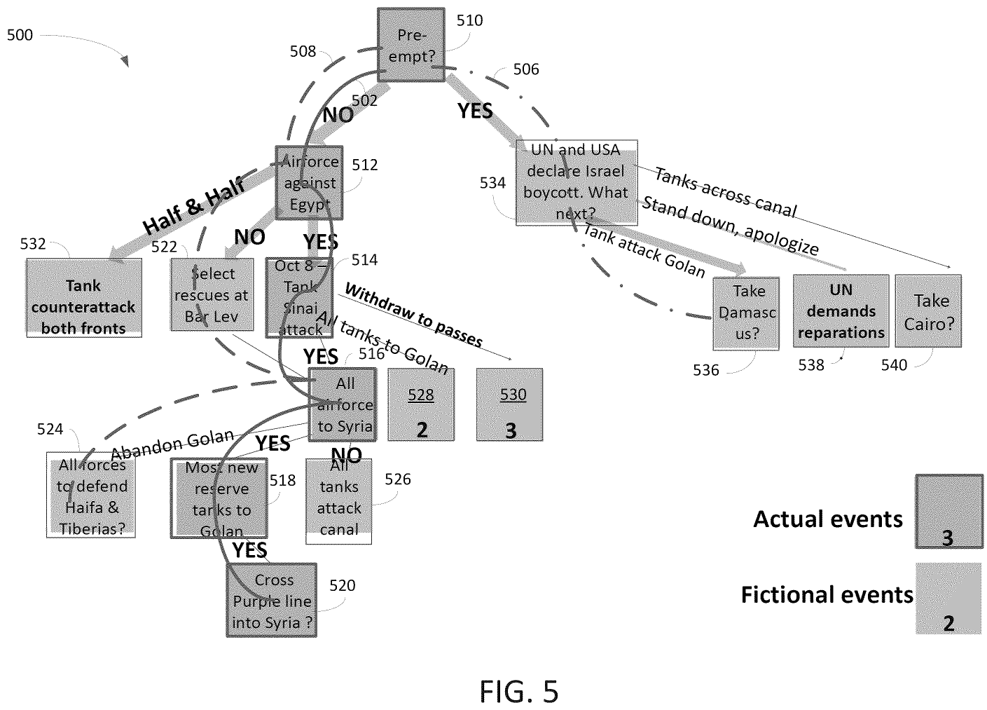

FIG. 5 is an event tree diagram 500 illustrating an exemplary rail tree containing multiple rails for emulating RCS in accordance with one or more embodiments of the present invention. Diagram 500 illustrates multiple possible rails or paths from block 510 including rails 502-508. A rail can be referred to as a sequence of actual or potential events based on a predefined time frame. In one aspect, rail 502 is an actual event that had happened in the past. It should be noted that the underlying concept of the exemplary embodiment(s) of the present invention would not change if one or more blocks (or networks) were added to or removed from diagram 500.

In one aspect, rail 502 includes blocks 510-520 representing actual events. For instance, at block 510, a player decides whether a preempt strike should be launched before Oct. 6, 1973 assuming the RCS is Yom Kippur War. Upon entering a “NO” option by the player, the process proceeds to block 512 in which Israel Defense Force (“IDF”) air force is activated against Egyptian force. After IDF tanks, at block 514, attack in Sinai if the player elects, IDF air force engages in Syria at block 516. Once the IDF reserved tanks, at block 518, enter Golan Heights on Egypt side, the IDF force, at block 520, crosses the border into Syria. It should be noted that a player is required to enter a selection at each block to move forward with RCS on a rail. Rail 502, in one aspect, is an actual historical recount of various events during Yom Kippur War.

Rail 506, in one example, illustrates a hypothetical or fictional path of events based on various parameters including experts' predictions and/or possibilities. Rail 506 includes blocks 510 and 534-536. For instance, at block 510, a player decides whether a preempt strike should be launched assuming the RCS is Yom Kippur War. Upon entering a “YES” option by the player, the process proceeds to block 510 in which IDF force launches a preemptive strike on Arab's forces. While, at block 534, the United Nations and the United States are likely to declare some kinds of boycott and/or sanctions, the IDF force is likely to take Golan Heights and Damascus using tanks and air force. Alternatively, the IDF force may send tanks across canal to reach Cairo at block 540 despite the boycotts by the UN and the US at block 534.

Rail 508, in one aspect, illustrates a hybrid path combining some actual events and some hypothetical events based on various parameters generated based on historical data as well as experts' predictions. For instance, at block 510, a player decides whether a preempt strike should be launched assuming the RCS is Yom Kippur War before Oct. 6, 1973. Upon entering a “NO” option by the player, the process proceeds to block 512 in which IDF air force decides not to engage against Egyptian force. After IDF, at block 514, selects to rescue and/or protect the Bar-Lev line, IDF air force engages in Syria at block 516. At block 524, the IDF, based on the player's selection, orders all force to defend Haifa and/or Tiberias. It should be noted that the player is required to enter a selection at each block to move forward with RCS. Rail 508 shows combination paths of some real events and some hypothetical events based on a historical data such as Yom Kippur War.

### Backpack of Variables

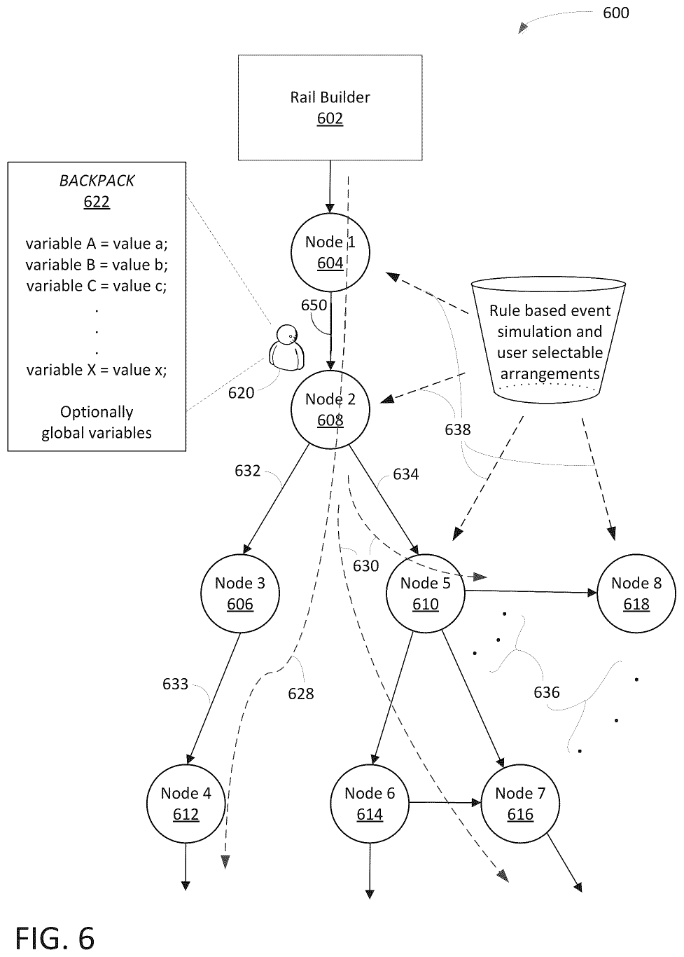

FIG. 6 is a block diagram 600 illustrating a rail tree containing multiple rails and nodes in a theater emulated via RCS in accordance with one or more embodiments of the present invention. Diagram 600 includes a rail builder 602, a user or player 620, a trail tree containing a first rail 628, a second rail 630. In one aspect, diagram 600 further includes a backpack 622 assigned to user 620. It should be noted that the underlying concept of the exemplary embodiment(s) of the present invention would not change if one or more blocks (or nodes) were added to or removed from diagram 600.

A video game system, in one embodiment, using RCS simulates a battle field based on at least in part on historical events. The system simulates rails containing multiple conflicting nodes or events based on in part historical theaters for a player or user to fight or walk through via a fighting force. While a rail or rails representing a sequence of conflicting path(s) in a historical recorded battle, the nodes along the rail(s) represent battles, fighting, and/or conflicts along the rail(s). When a player or user elects himself or herself as a commander of in force, the system assigns a backpack of variables to the player as his or her resources for fighting through the node. The player's resources include, but not limited to, armed force, morals, national opinions, international supports, and supplies. The resource allocated to each player or user is at least in part represented by values of variables assigned to each player. After offering an option to the player or user for rearranging player's fighting capabilities, the system generates a score or outcome which assesses player's real-time decision-making capabilities.

Upon election of a particular battle field or theater, rail builder 602 is able to build a selected battle field using rails 628-630 and nodes 604-618. Rail builder 602, in one embodiment, includes a database builder, a database, and a processor. In one example, the RCS system is able to obtain data from local storage, remote storage, and/or online resources via networks.

A rail tree contains multiple rails 628-630 including point-to-point (“PTP”) nodes such as node 604-606 and node splitters 608-610. PTP nodes 604-606 and splitter nodes 608-610, in one embodiment, are similar nodes representing events along a rail or rails based on historical events and/or actual geographic terrains. PTP node such as node 606 has one up-node connection 632 and one lower-node connection 633. Splitter node such as node 608, on the other hand, includes one up-connection 650 and two lower-node connections 632-634.

A function of PTP node such node 604 is able to facilitate a player such as user 620 to move from node 604 to node 608 with user's variables in backpack 622. For example, if a battalion of soldiers has left behind in node 1 604, the RCS system updates some values of variables associated to user 620 to reflect that user 620 has less soldiers. It should be noted that each node is operable via rule-based event simulation and user selectable arrangements as indicated by numeral 638.

The splitter node such as node 608, in one embodiment, provides an option to a player such as user 620 to whether staying on the original rail such as rail 628 or branching off to a new rail such as rail 630. In some examples, splitter node such as node 610 can branch to one of multiple rails as indicated by numeral 636. In one example, node-5 610 can lead a user to node-6, node-7, or node-8 depending on rail results calculated by a prediction simulator using, for example, the Monte Carlo method in response to values of variables assigned to user 620.

Backpack 622, in one aspect, includes a group of variables associated to a particular user such as user 620. Each variable such as variable-A contains value a. Value a can be a real or imaginary number. In one example, backpack 622 or bag of variables is assigned to a player such as user 620 and backpack 622 follows the player walking along the rails. The player, for instance, travels (or fights through the battle field) on pre-designed event rails and carries backpack 622 representing t player's available resources. The player or user 620 carries backpack 622 moving between the nodes on rails emulated by the system. The system, in one aspect, using a computational game calculator calculates results or outcomes of a battle using the Monte Carlo algorithm. In order to generate (or force) an outcome for the nodes on rails, the RCS system herds the data given by the algorithm through variable range gates and backs onto pre-defined rails.

Variables in backpack 622, in one example, are set to store real numbers, imaginary numbers, or a combination of real and imaginary numbers. It should be noted that initial values or numbers for the variables are defined by the RCS system. The values of variables represent at least in part the fighting strength associated to the player such as user 620. The values of variables also indicate the resources possessed by the player.

In operation, a process capable of facilitating user progress or movement on a rail such as rail 628 emulated by RCS simulates rail 628 containing node-1 604 to node-4 612 emulating a theater or a battle field in accordance with at least in part on the recorded historical facts. After facilitating a player or user 620 traveling on rail 628 approaching to an event or node-2 608 from a first direction such as a direction from node-1 to node-2, and a second player, not shown in FIG. 6, traveling on rail 628 approaching to node-2 from a second direction such as a direction from node-3 606 to node-2 608, resource options are presented to players for rearranging, upgrading, downgrading, and/or reenforcing their resources and/or weaponries based on players' resources and movements. It should be noted that rearranging players resources include trading their values of variables in their backpack for weapons and soldiers. Upon engagement of the node or battles, scores and/or outcomes are generated based on a prediction calculation using a Monte Carlo simulator as well as global variables.

The RCS system, in one aspect, is capable of maintaining continuous existence of a unit even if the unit is substantially destroyed in the battle or node. The crippled or destroyed unit, in one example, can be replenished at a later time based on a set of predefined rules. A benefit for a unit to be immortal is that the unit or its name of unit such as the fifth army can still exist even though there is no one left in the unit at the moment.

The unit immortality, in one embodiment, is a unit (e.g., military entity) which can get severely damaged in battle but never gets completely destroyed or disappeared. For example, a unit identifier (“ID”) will continue to exist even if all soldiers and/or assets are completely vanished. When soldiers in a battalion or squadron in air force have been destroyed, its unit IDs, however, still exist. For example, army can mobilize new recruits or transfer soldiers from other units to replenish the understaffed and/or under supplied units. The RCS system, in one embodiment, maintains units which could incur heavy losses but will not be eliminated or wiped out from the game maps.

Backpack 622, in one embodiment, further includes one or more global variables. Global variables, for example, can change outcome(s) for the battle based on events and player's decisions. For example, during a simulation of Yom Kippur war, the global variables may include Israel economy status, international support to Israel, Israeli public morale, Egypt public morale, Syrian public morale, American policies towards Israel and Arabs, and/or Russian foreign and military policies toward Arabs and Israel. The RCS system allows the global variables visible to player(s) throughout the game via an icon labeled, for example, “global variables.” While such global variables may be controlled by the player through his or her conduct and/or decisions, the global variables can always change over time based on events that happen during the course of battle. For example, a player could choose to bomb Damascus which would result in change of global variables. Also, when Egyptian army attacks Israel which may not be controlled by the player, the values of global variables for the player who plays on behalf of Egyptian army may change. When variables reach certain levels or values, the global variables can trigger the start of predesignated events. For example, if the value of global variable for American policy towards Israel goes above certain level, a military airlifting takes place. Alternatively, if the value of global variable for American policy towards Israel stays at a certain level, no airlifting occurs.

Depending on the values of variables including global variables in backpack, the RCS system employs one or more rule-based variable processors to predict a likelihood outcome based on a prediction algorithm such as Monte Carlo method.

An advantage of using values of variables associated to each player is to allow the simulation system using mathematical formulars such as Monte Carlo method to predict a likelihood outcome based on the player's decision as well as historical facts.

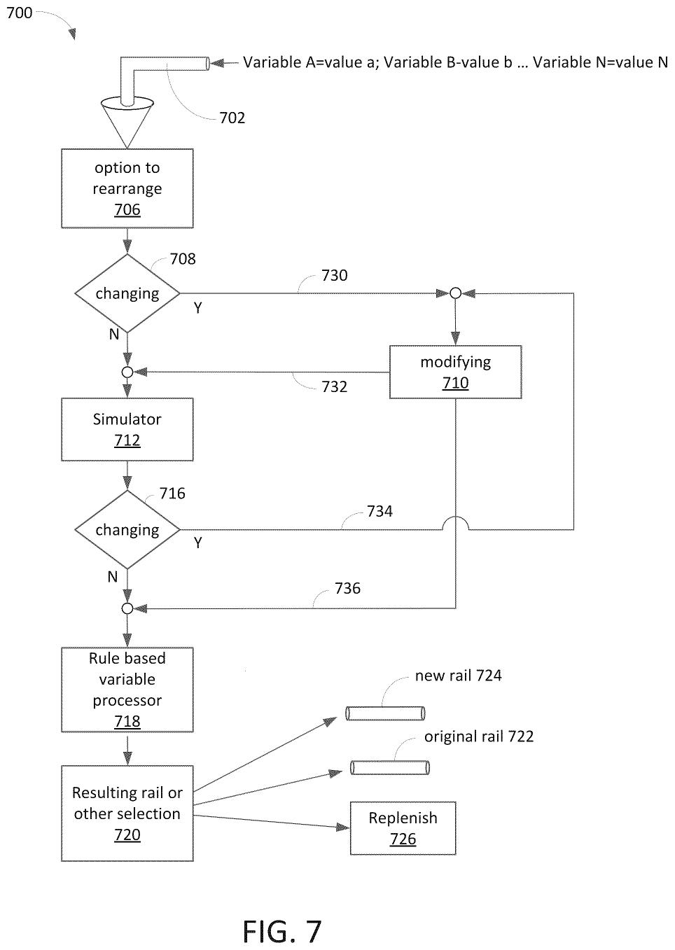

FIG. 7 is a logic block diagram 700 illustrating a process of moving or progressing a player between nodes on a rail emulating by RCS in accordance with one or more embodiments of the present invention. To facilitate movement or progress a game player or user from one node to another, the RCS system activates a variable accumulator 702 for obtaining values corresponding to variables associated to each player. It should be noted that the values can be real-numbers, imaginary numbers, and/or combination of real and imaginary numbers. The terms “player”, “game player”, and “user” are referred to the same or similar person and they can be used interchangeably. It should be noted that the underlying concept of the exemplary embodiment(s) of the present invention would not change if one or more blocks (or nodes) were added to or removed from diagram 700.

Upon obtaining variables from backpack associated to a player, an option to rearrange player's assets or resource is presented to the player at block 706. If the player elects to change or rearrange his or her resource or assets at block 708, the process proceeds to modifying block 710 as indicated by numeral 730. For example, the player can add another battalion of soldiers using some of the values of variables in the backpack. After modification, the process proceeds to simulator block 712 as indicated by numeral 732. If, however, the player declines to rearrange player's assets, the process proceeds to simulator block 712. It should be noted that the player's asset possession or player's asset refers to player's armed force including, but not limited to, number of fighters, ships, tanks, battalion of soldiers, supplies, and the like. Simulator block 712 includes a Monte Carlo prediction simulator capable of predicting a likelihood outcome in light of values of variables and other player's resources at the node.

After simulating an outcome, the process proceeds to block 716 to present an option to the player offering another opportunity to rearrange or modify player's resource or assets. If the player elects the option to modify at block 716, the player can rearrange or modify player's assets to prepare for the next node or event as indicated by numeral 734. Upon rearrangement or modification, the process proceeds to block 718 as indicated by numeral 736. If, the player elects not to rearrange or modify at block 716, the process proceeds to block 718.

At block 718, a rule-based variable processor is used to calculate the next node as well as connections on the rail that the player can be on based on rules, outcome of simulator block 712, and variables from all players. In one aspect, block 718 generates one or more results for each player to facilitate navigation of player's next node. Based on the result(s) of calculation, the resulting rail and/or other selection(s) are automatically elected at block 720 for the player. For example, the player may be able to remain on the original rial 722 if the result for the player reaches to a predefined level. Alternatively, the player may be forced to move onto a new rail 724 if the score for the player fails to reach to the predefined level. In another embodiment, the player is entitled to replenish his/her resource at block 726 based on a set of predefined rules.

The RCS system, in one aspect, is capable of providing a score or scores for each player at the end of video game. Based on various fronts or factors, a score or report is generated at the end of game based on the rules, resource consumed, casualties, damages, territorial gains, international influences, and city or territorial loss. For example, during RCS based on the 1973 Yom Kippur War, a final report, such as Agranat Commission Report, is generated summarizing various fronts, such as, but not limited to, Sinai, Golan, Russia, the US, and diplomatic resolution(s). At the end of each game, the player, for example, receives an ending result for each front. Such ending results, in one aspect, would be used, accumulated, and combined into the final report (or Agranat Commission Report) to generate players' overall scores. In one embodiment, the RCS system provides an opportunity for the player to compare his/her campaign records against the actual Agranat Commission report generated by the historical commission.

It should be noted that global variables can affect player's overall numerical score. For example, the score is formulated into one single number which ranks player's performance. Analyzing and ranking players' performance allow the RCS system to analyze player's dynamic real-time performance rather than a system defined outcome.

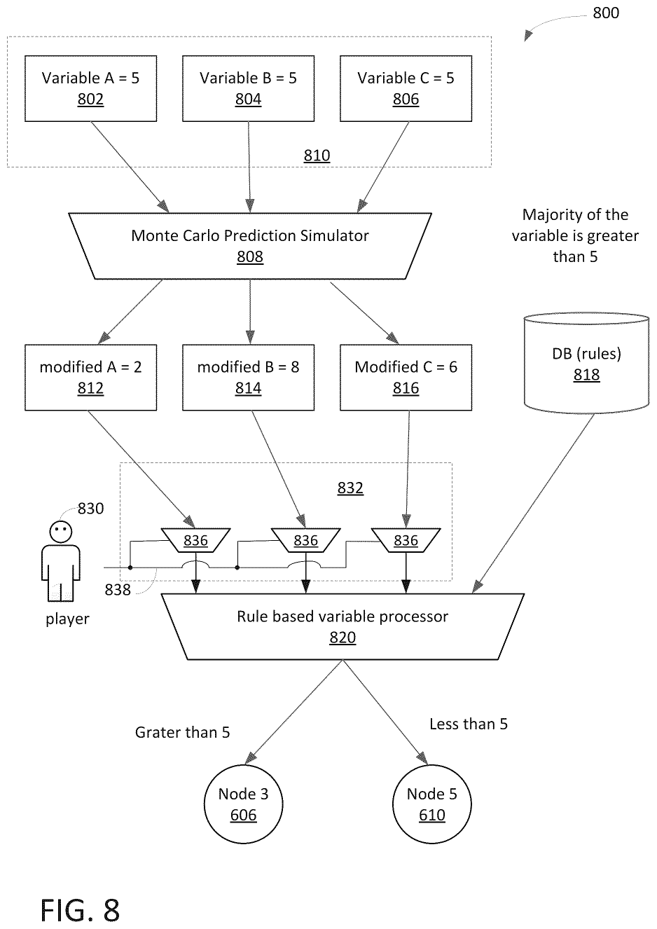

FIG. 8 is a block diagram 800 illustrating an exemplary logic process progressing between nodes on one or more rails under RCS in accordance with one or more embodiments of the present invention. Diagram 800 includes backpack 810, Monte Carlo Prediction Simulator 808, rule database (“DB”), and rule-based variable processor 820. In one aspect, backpack 810 is designated to player 830 to walk through a rail. Note that the most of steps illustrated in diagram 800 are generally performed for every node on a rail. It should be noted that the underlying concept of the exemplary embodiment(s) of the present invention would not change if one or more blocks (or nodes) were added to or removed from diagram 800.

Backpack 810 includes a group of variables wherein each variable may contain a value. In the presently disclosed exemplary embodiment, backpack 810 contains variable-A 802, variable-B 804, and variable-C 806. In this example, variable-A 802, variable-B 804, and variable-C 806 are initially set to value 5. Upon obtaining variable-A 802, variable-B 804, and variable-C 806, prediction simulator 808 calculates and/or modifies variable-A, variable-B, and variable-C using the Monte Carlo method. Prediction simulator 808 subsequently generates a modified variable-A containing a number 2, modified variable-B containing a number 8, and modified variable-C containing a number 6 as indicated by numerals 812-816.

At block 832, an option to rearrange or update values of variable is offered to player 830. For example, player 830 can trade up or exchange his or her armed force before engaging in the event or battle at the node. It should be noted that armed force upgrade or downgrade is reflected by the values of variables. Variable updating components 836 are controlled by player 830 via control connections 838. Player 830, in one example, is provided an opportunity to update or rearrange player's values of variables before reaching to rule-based variable processor 820.

After fetching a set of rules from rule DB 818, rule-based variable processor 820 calculates and generates a result based on the values of variables and the rules. The result, also known as value of resulting rail, is a number that determines which node will be the next node for the player to move to. For example, if the result is great than 5, the next node will be node-3 606. If, however, the result is equal or less than 5, the next node for the player will be node-5 610.

Rule DB 818, in one embodiment, contains a set of rules for every node on each rail wherein a node represents an event based on a historical event. A node, in one aspect, represents an event which illustrates a predefined duration of a battle or fight partially based on historical facts as well as actual geographic terrain. For a player traveling through a node which indicates a fighting through the geographic terrain against one or more hostile forces, a likelihood outcome or result after the battle is generated or predicted via a prediction method such as Monte Carlo method. The prediction method is performed by rule-based variable processor 820 according to the rules and player's armed force reflected by the variables in backpack after engagement of the battle. Depending on the player's election and/or real-time performance, the outcome or result shows at least in part a score of player's cognitive performance.

In operation, a video game using RCS receives and/or collects inputs or requests from a user or player requesting activation of a particular rail of a theater emulating a historical war. For instance, a player can enter a request to play the day-3 at Migdal battle field as a commander of Israeli air force during the 1973 Yom Kippur war. Upon facilitating the user or player to travel on the rail approaching to the battle field, RCS obtains variables containing values in a variable backpack designated to the user or player. RCS offers opportunities for the player to rearrange and/or modify his or her armed force or regiment. For example, RCS presents a resource option to the player allowing an option of modification or exchange a portion of values of variables to upgrade user's weaponry. After activating a computational module to calculate a set of updated values associated to the variables in response to the modification, an outcome or result of the battle is scored in response to a set of rules and the set of updated values.

An advantage of using rules and values of variables is that it can enhance accuracy of predication of a likelihood outcome using mathematical formulars for a battle field. The likelihood outcome can be predicated for the wars occurred in the past as well as in the future depending on the applications.

The exemplary embodiment of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components.

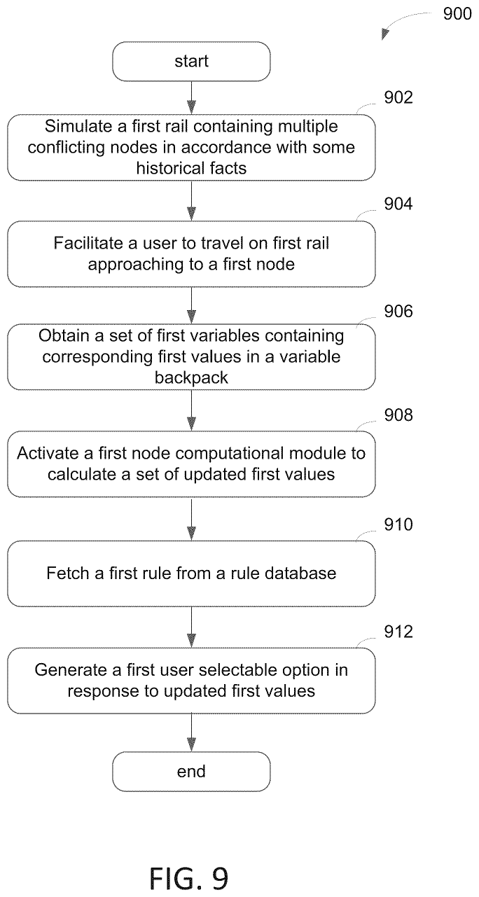

FIG. 9 is a flowchart 900 illustrating an exemplary process of RCS emulating a player's progress or movement between nodes on a rail in accordance with one embodiment of the present invention. At block 902, a process capable of facilitating a movement or progress of a player on a rail with a sequence of events or nodes emulated by RCS provides a selected rail containing multiple conflicting nodes emulating a theater in accordance with at least in part based on recorded historical facts. The rail, in one example, includes one or more rail splitters along the rail for branching to one or more new rails.

At block 904, the player or user travels on the rail approaching to one of the conflicting nodes. In one aspect, the process is able to identify a location along the rail in which the user or player is currently on. In one embodiment, the RCS system is capable of superimposing the player's current location over a map showing geographic attributes of a battle field.

At block, 906, the process obtains multiple variables having corresponding values in a variable backpack which is designated to the user or player. It should be noted that the values of variables can be integer, real-number, imaginary number, and/or a combination of integer, real-number, and imaginary number.

At block 908, a computational module at the node is activated to calculate a set of updated or modified values associated to the variables in response to the corresponding values. In one aspect, the process initiates an estimator based on the Monte Carlo method to facilitate generation of the updated or modified values in accordance with input parameters and predefined rules associated to the node. The parameters, in one example, includes number of soldiers, weapons, morals, and/or supplies based on at least in part on historical facts.

At block 910, a set of rules are fetched from a rule DB based on the node. In one aspect, the rule DB stores rules for each node on the rail. In one example, rules are used to reflect the battle conditions, armed forces, geographic terrains, public opinions, an soldiers' moral at least in part based on historical facts.

At block 912, the player is offered an option to rearrange or reenforce player's fighting capabilities based on values of variables. For example, the player may modify or alter his or her military assets for continuing staying on the current rail based on the arrangement of hostile forces. Alternatively, the player can rearrange his or her regiment based on opposing force for taking the split option to a new rail. After detecting the player and electing rail, an elected RCS environment containing the rail is simulated at least partially based on historical facts. RCS, in one aspect, is also capable of facilitating a second user or player to travel on the rail approaching to the node from an opposite direction. In operation, after identifying and creating an environment to simulate a selected theater, a map containing geographic parameter associated with the theater is generated in accordance with geography relating to the historical event. Upon generating armed force as a military parameter associated with the user or player in accordance with the historical event, a map storage for storing the relevant maps and armed force storage for storing the soldiers are created in the local system.

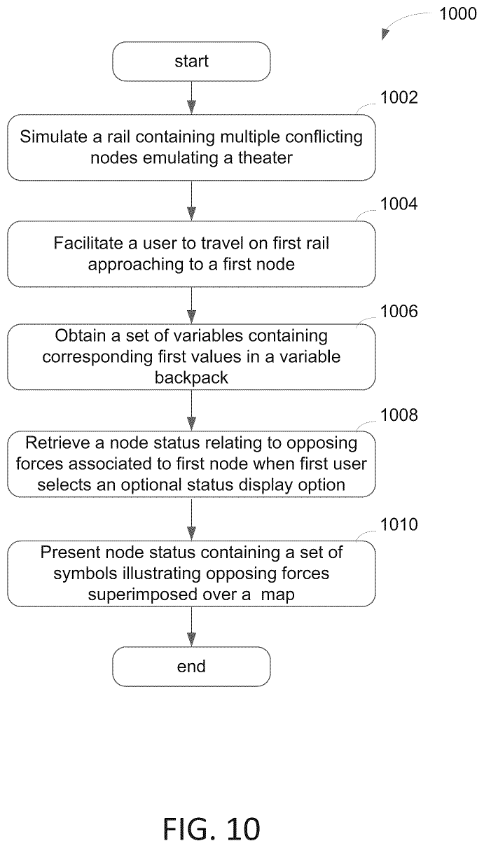

FIG. 10 is a flowchart 1000 illustrating an exemplary process of RCS emulating symbols superimposed over a map showing movements between nodes on a rail in accordance with one embodiment of the present invention. At block 1002, a process capable of facilitating progress of a player on a rail simulates a rail containing multiple conflicting nodes emulating a theater in accordance with historical facts.

At block 1004, the player or user is facilitated to travel on the rail approaching to a destination node.

At block 1006, the process obtains a set of variables containing corresponding values in a variable backpack designated to the player or user.

At block 1008, a node status relating to the opposing or hostile forces associated to the node is retrieved when the user selects an optional status display option.

At block 1010, the node status containing symbols illustrating the opposing forces superimposed over the map is presented. In one example, the process presents the optional status display option allowing the player or user to elect. In one example, the size of a symbol representing strength of a forces is displayed. For instance, a bigger symbol representing the opposing force indicates that the opposing force has a larger force. An arrow symbol represents the origin of a force.

### X-Map

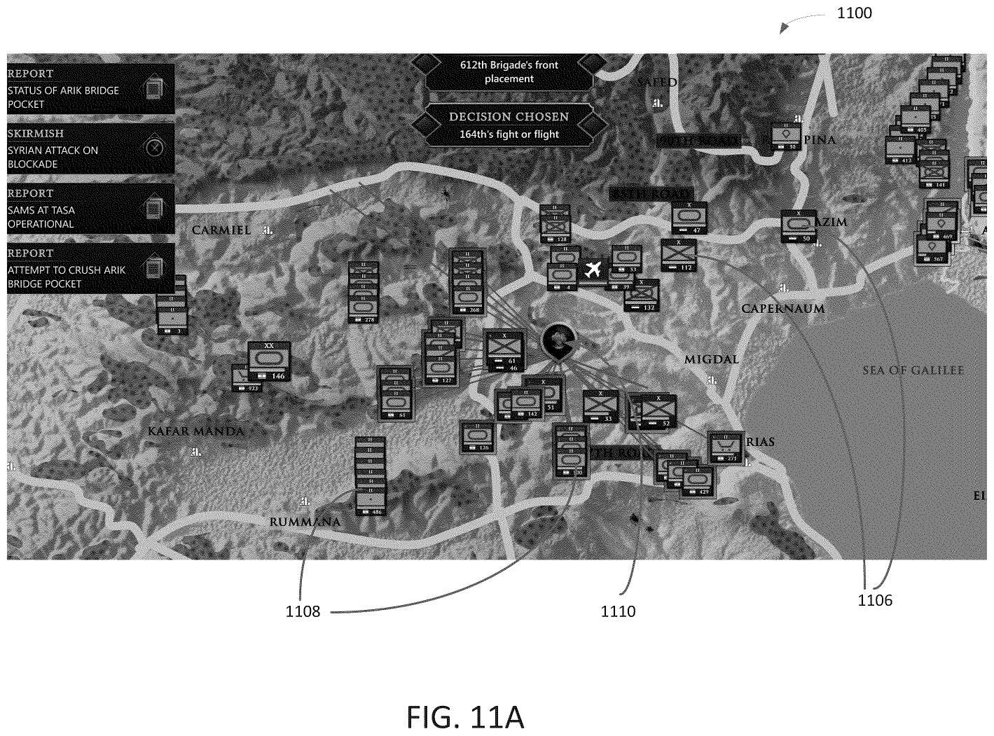

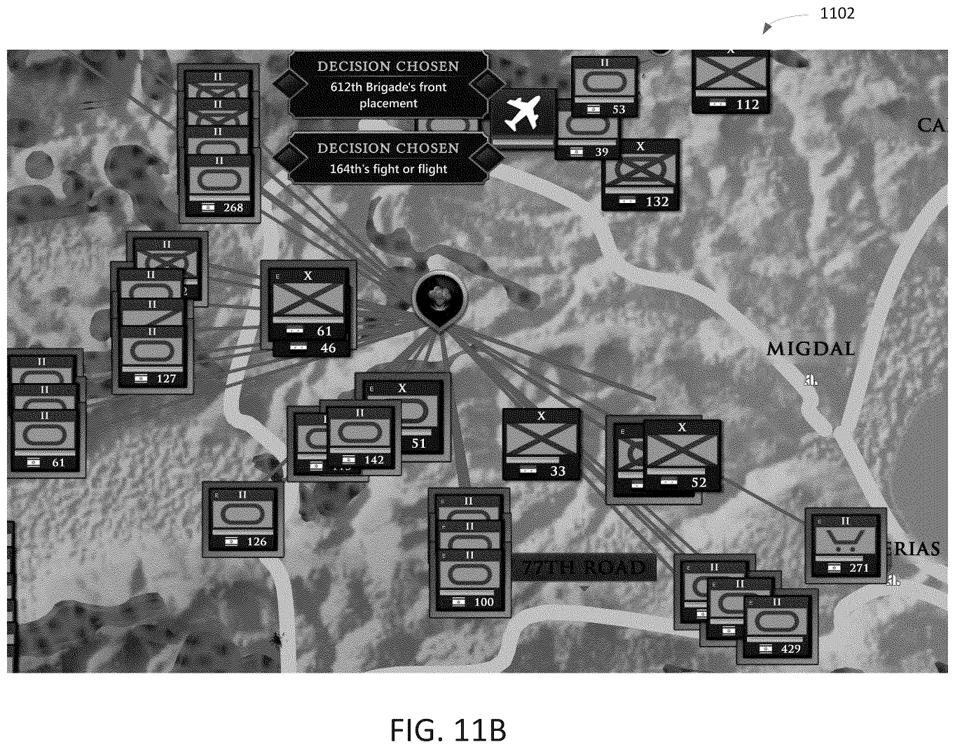

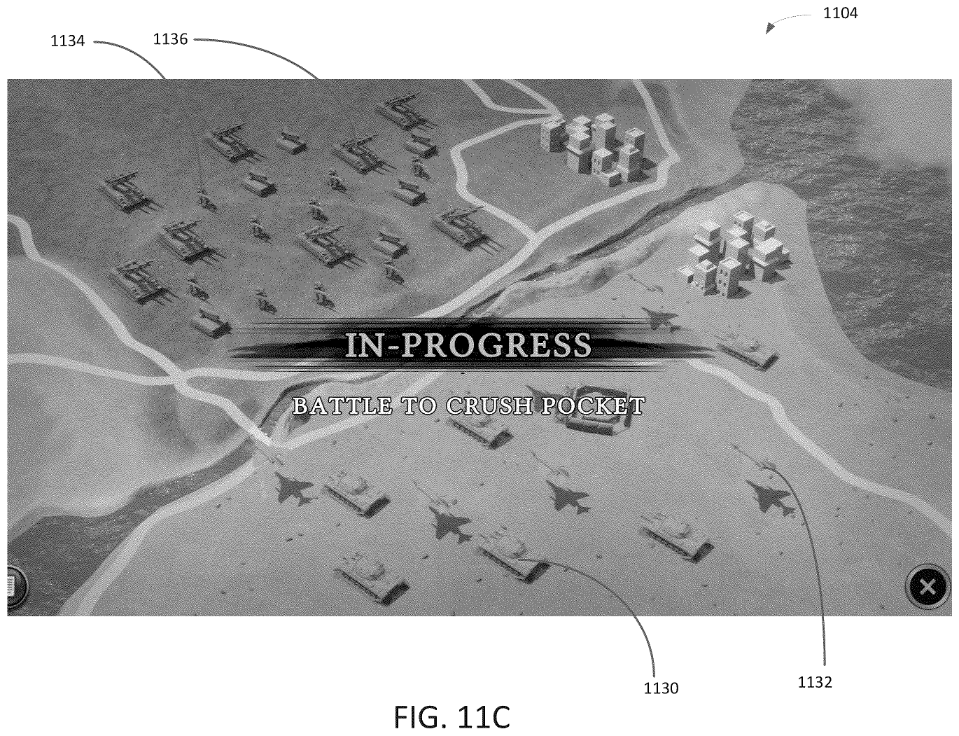

FIG. 11A is a map 1100 containing geographic terrains illustrating a battle field having symbols superimposed over the map in accordance with one embodiment of the present invention. Map 1100 illustrates a battle field around Migdal during 1973 Yom Kippur war. Map 1100 illustrates red blocks 1106 representing Arab forces while blue blocks representing Israeli forces 1108. The Arab forces and Israeli forces were engaged at node 1110. Map 1100 illustrates an exemplary map that allows symbols such as fighter squadrons and/or army units to superimpose over a map. RCS, in one embodiment, offers an icon of map to the player and the player can click the icon at any time to bring up the map such as map 1100 to evaluate the status of engagement. It should be noted that the underlying concept of the exemplary embodiment(s) of the present invention would not change if one or more blocks (or symbols) were added to or removed from map 1100.

It should be noted that on the live game map, there are objects (special vehicles and other movable systems) that while in motion might be non-operational. These objects, after arriving at their stationary destination, need some preparation time before they can be activated. For example, a movable missile truck is not able to fire its missile while in transit. Once arrival at the battle field, the missile truck, for example, needs a two-hour setup time for the missile to be operational. Such objects, also known as entities, have their parameters programmable; in particular, speed of travel, time needed to make the unit operational after the travel, degree of its inoperability (unit might be only partially, ex. 50% inoperable), time to repair a damaged unit, time needed for maintenance of the unit, range of fuel needed to make unit operable. In one embodiment, such objects can be presented in the live game map or map to show such hardware or entities with operational indicators.

FIG. 11B is a map 1102 containing geographic terrains illustrating a battle field having symbols superimposed over the map in accordance with one embodiment of the present invention. Map 1102 is a zoom-in or magnified section of map 1100 shown in FIG. 11A. In one aspect, RCS allows a player or user to enlarge or zoom in the map to see additional details relating to various forces and movement around the node or battle field. In another embodiment, RCS also provides an option to zoom out whereby the player can see additional troops movements in a larger geographic area.

FIG. 11C is a map 1104 containing geographic terrains illustrating an engagement of two forces in a battle field having symbols with a three-dimensional (“3D”) effect superimposed over a map in accordance with one embodiment of the present invention. In one embodiment, red force 1134-1136 is prepared to cross a river while blue force 1130-1132 is trying to engage with red force 1134-1136. With a 3D live game map, a player is able to make a better decision when various attributes relating to forces 1130-1136 are illustrated. For example, red force 1134-1136 has more soldiers 1134 backed by missiles 1136 while blue force contains tanks 1130 supported by aircrafts 1132. Depending on the player's judgement, he or she may reenforce additional forces to obtain a better outcome or a higher score.

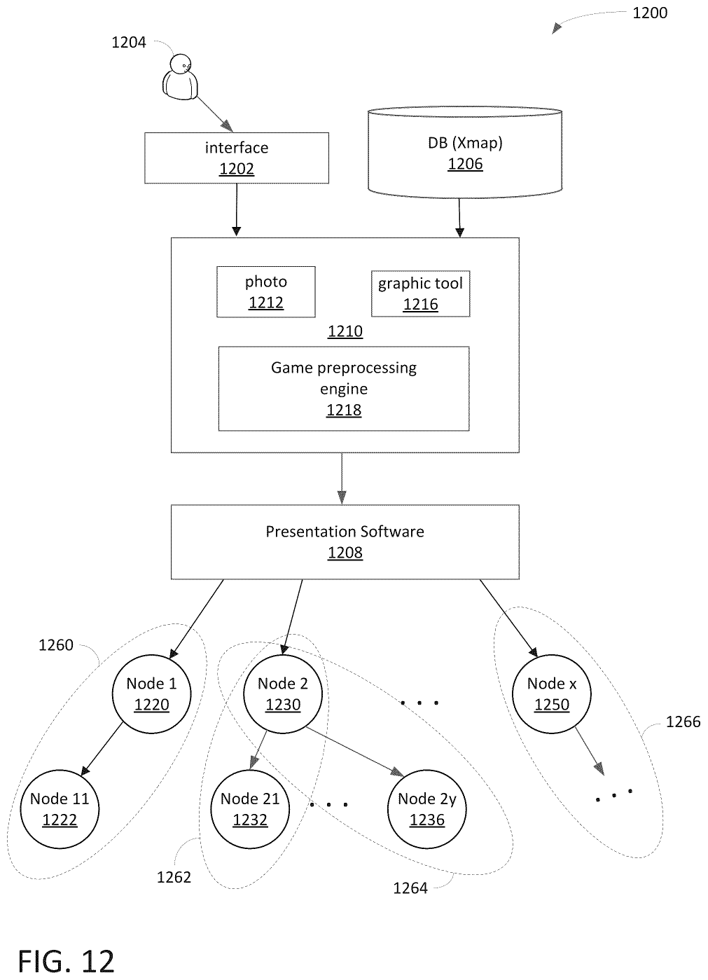

FIG. 12 is a block diagram 1200 illustrating a logic process of Xmap used to facilitate visual illustrations relating to maps, images, and/or illustrations of a battle(s) in accordance with one or more embodiments of the present invention. Diagram 1200 includes a user 1204, interface 1202, database 1206, Xmap component 1210, presentation software 1208, and story lines 1260-1266. In one aspect, Xmap component 1210 further includes a photo unit 1212, graphic tool unit 1216, and processing engine 1218. It should be noted that the underlying concept of the exemplary embodiment(s) of the present invention would not change if one or more blocks (or symbols) were added to or removed from map 1200.

Presentation software 1208 is computer software capable of managing a video game via interactive story lines, characters, and/or variables. For example, presentation software 1208 may include Articy® language to manage or facilitate progress of a game. It should be noted that presentation software 1208 is coupled to a visual database such as DB 1206 to maintain story lines, characters, and/or variable for each node on a rail. In one embodiment, presentation software 1208 maintains and/or facilitates various possible rails 1260-1266 wherein each rail includes one or more nodes 1220-1250.

A function of presentation software 1208 is to manage and/or provide a real-time progress of a video game played by one or more players or users. To provide an interactive game environment, presentation software 1208 generates and/or maintains multiple rails such as rails 1260-1266 including various visual representations. Some rails may be current events while other rails can be possible or potential rails if a player(s) chooses to do so during the game.

Each rail includes one or more nodes. For example, rail 1260 contains nodes 1220-1222 while rail 1262 includes nodes 1230-1232. In some cases, rails are hypothetical or passible paths based on certain predefined conditions as well as players' selections. For example, under a player's first selection, a player moves from node 1230 to node 1232 following rail 1262. When a player elects a second selection, the player moves from node 1230 to node 1236 following rail 1264. Since the progression of a game involves various factors, Xmap is configured to generate various actual as well as possible rails such as rails 1260-1266 in real-time.

Presentation software 1208, which can be Articy® based software, is able to overlay plug development tool such as Xmap component. It should be noted that story lines (story boards) of a game is generally developed or evolved at game time situation which uses image processing software such as Photoshop. To simplify and speed up development of story line(s) in a game, graphic tool unit 1216, as dedicated tool, incorporates functionalities of Photoshop like graphic tools to assist game preprocessing engine 1218 for generating output to presentation software 1208. For example, an electronic story board generates visual illustrations as input data to the game/softaware-symultor/imagined-story (e.g., Articy system) feeding directly to the final playing game or story presentation software like Unity, Unreal, Lumberyard or CryEngine system.

A function of Xmap component 1210 is to generate various actual and/or possible visual illustrations for a sequence of maps representing current conflicting nodes. For example, Xmap component 1210 provides and/or manages real-time or near real-time map updates based on user or player selection. Based on user's input and the data stored in database 1206, Xmap component 1210 is able to generate multiple graphic illustrations or maps relating to multiple story lines or rails concurrently.

Photo unit 1212, in one embodiment, is configured to handle photos or images including overlaying or superimpose multiple images, items, or symbols onto a map or current map. Photo unit 1212, in one example, is a photoshop like software capable of manipulating and/or altering images. Graphic tool unit 1216 provides image representation showing game progression using overlaying method such as photo unit 1212. Graphic tool unit 1216, in one example, automatically converts graphic elements (sequence of Photoshop types of elements) into Articy language elements in real-time. In one embodiment, graphic tool 1216 is able to duplicate or enhance output of photo unit 1212 before sending it to preprocessing engine 1218. Upon processing, preprocessing engine 1218 generates outputs for presentation software 1208 which is used to facilitate the progress of a video game.

To illustrate images, Xmap component 1210 generate moving tile or movement tile (also known as Articy tile if Aritcy software is employed) which is automatically created by Xmap component 1210. When a given military unit moves on a rail or path from one map location to another map location, the movement tile (or Articy tile), for example, is responsible for that movement which is automatically created inside a performance flow fragment within presentation software 1208. It should be noted that a player or user decision can easily bifurcate storylines from a few storylines to many storylines.

Another function of Xmap is to copy and/or transfer one slice of rail or a sequence of slices to another rail(s). It should be noted that a rail can be divided into multiple slices for graphical illustration since each screen can display limited information. To have a fast way of developing new and/or similar sequences of a game, copying and/or duplicating sequences of slices is implemented. Upon modifying the sequences, a new sequence which is similar to some previous sequence is produced. A string (tree branch, a campaign) can easily be copied to become a starting point for a new string to design a new campaign that is similar to the first one, but with some changes. For example, one campaign has a battle in it in the middle that results in a death of a commander. The second campaign is almost identical, but the commander in this case did not die in the battle.

An advantage of employing Xmap is that Xmap facilitates simultaneous visual illustrations for one or more players during a video game.

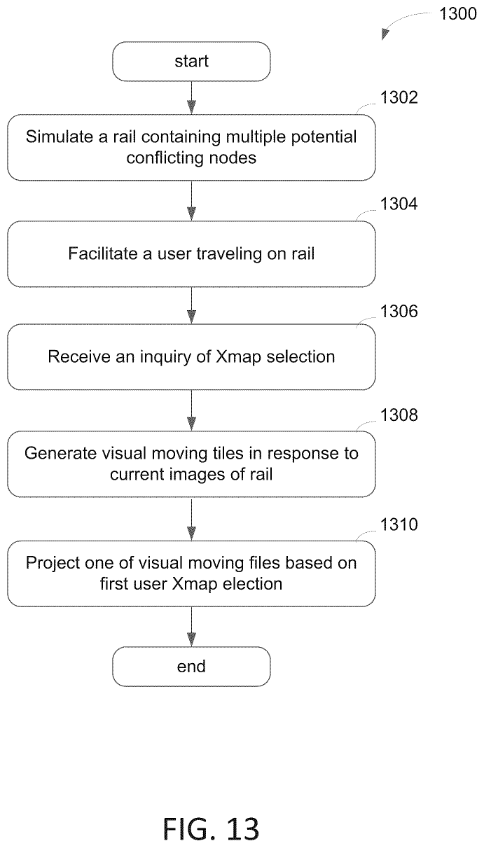

FIG. 13 is a flowchart 1300 illustrating an exemplary process of Xmap facilitated by RCS in accordance with one embodiment of the present invention. At block 1302, a process of RCS using Xmap for facilitating visual illustrations showing a sequence of events based on some historical events simulates a first rail containing multiple potential conflicting nodes emulating a first theater in accordance with at least a portion of recorded historical facts facilitated by the RCS system. In one example, one or more rail splitters are identified along the first rail coupling to some other rail including new rails or hypothetical rails.

At block 1304, the process facilitates a first user to travel on the first rail approaching to a first node of the conflicting nodes. A location, for example, is identified along the first rail in which the first user is currently on.

At block 1306, an inquiry of Xmap selection is received for visual illustration one or more possible story lines based on the first rail, second rail, and user input. In one embodiment, a process of imaging processing and photo-editing are initiated to creating visual moving tiles or screen images representing a visual display showing at least a portion of elements distributed over a section of the first rail or the second rail. In one embodiment, the process is capable of obtaining an Xmap command initiated by the first user requesting a display of an interactive map showing a portion of the first rail in response to one or more selected objects. For example, a unit preparation map is displayed showing one of multiple story lines relating to object preparations in accordance with predefined parameters, user selections, and the first rail. Alternatively, prisoner camps are displayed showing one of multiple story lines relating to size and number of prisoner camps object in accordance with predefined parameters, user selections, and the first rail.

At block 1308, multiple moving tiles are generated in response to current images of the first rail and images of second rail in accordance with conversion of graphic elements into Xmap language elements. In one example, the process retrieves historical battle events corresponding to various conflicting nodes on the first rail.

At block 1310, the process projects the moving tiles visually illustrating images based on the first user Xmap election. In one aspect, the process is further capable of restoring status of the first rail and the location of the first user on the first rail after inquiry of Xmap is completed.

### Unit Preparation Mode

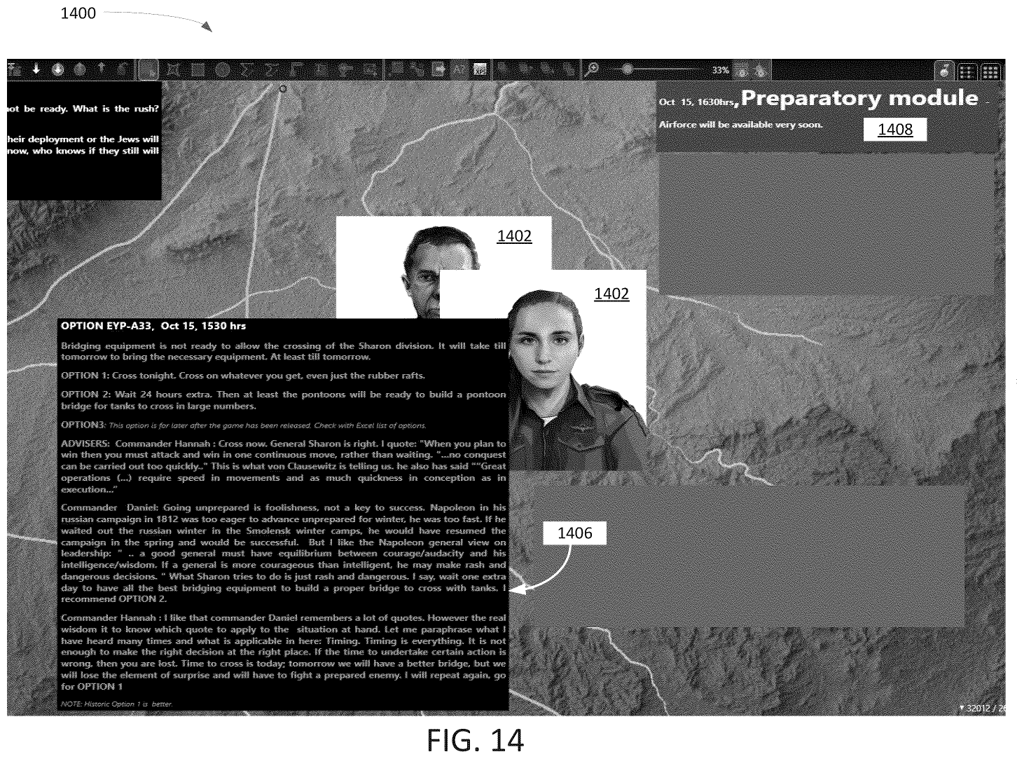

FIG. 14 is a block diagram 1400 showing a visual illustration or map facilitated by Xmap relating to object preparation or unit preparation simulated by RCS system in accordance with one or more embodiments of the present invention. Diagram 1400 illustrates images of offices 1402, dialogue box 1406, and preparatory module option 1408 which is used for unit or object preparation. Dialogue box 1406 shows a discussion of people or offices 1402 of two opposing views relating to current preparation status. In one aspect, unit preparation offers options to a user or player to play the game. For example, options for selecting types of preparation are presented to player(s) before the player(s) decides on activation of the preparation process. Preparatory module option 1408 is used to allow a user or player to choose which military unit(s) and how to prepare the unit(s). It should be noted that the underlying concept of the exemplary embodiment(s) of the present invention would not change if one or more blocks (or symbols) were added to or removed from map 1400.

To handle a process of game object preparations, each object (military unit, air force base, military fort) may be subjected to preparation processing in order to improve its properties. It should be noted that the time for processing a unit preparation is difficult to be predetermined since the preparation time is chosen by the player during the game. The value of preparation time is unknown before the start of game. Depending on the value selected by the player from a list of options of predefined values, various outcomes of story lines are possible. To handle these various outcomes, pre-defined separate story tree branches for each possible outcome may be created. During the game play time, we test the player's selection of control variable values are monitored and detected in order to select in real-time (on fly) which of the predetermined game branches the game should take.

In operation, possible values that the player can choose will be funneled (mapped) into two or three possible ranges via Xmap. Each range will have its own and separate story branch. The predefined movement sending a unit that is in preparation mode into battle may be illustrated. When a player's chose of a preparation time that overlaps with a decision to send a unit or units somewhere, the unit is to be moved but not getting involved it in the battle or skirmish calculations. A trade-off is created for a player because the player can choose to improve the units values which can help the player to win the upcoming battles. Alternatively, if a unit is in preparation mode, it cannot participate in battles or skirmishes. Options used in Xmap preparation menu provide whether a unit or units are going to undergo a preparation process. The preparation process, for example, can involve troop resting, equipment maintenance, training of special skill (i.e., fighting against saggers (missiles) etc.).

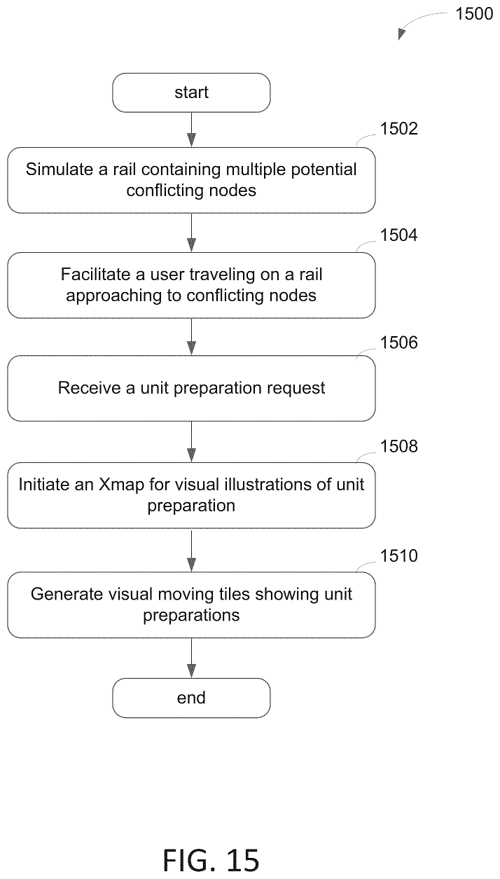

FIG. 15 is a flowchart 1500 illustrating an exemplary process of Xmap simulated by the RCS system capable of emulating an object preparation in accordance with one embodiment of the present invention. At block 1502, a process of RCS using Xmap for facilitating visual illustrations showing a sequence of events simulates a first rail containing multiple potential conflicting nodes which emulate a theater in accordance with at least a portion of recorded historical facts facilitated by the RCS system.

At block 1504, a user (or first user) is identified and facilitated to travel on the first rail approaching to a first node of the conflicting nodes. The user in one example is a user or player. In some embodiments, a second user or a third user may be present for playing the game.

At block 1506, a unit preparation request is subsequently received for illustrating one of multiple story lines relating to object preparations in accordance with predefined parameters, user selections, and the first rail. In one embodiment, a process of imaging processing and photo-editing is activated or inactivated to creating visually moving tiles or screen images representing a visual display of unit preparation showing at least a portion of elements distributed over a section of the first rail or the second rail.

At block 1508, an Xmap is initiated for visual illustrations of unit preparation with one or more possible moving tiles based on the first rail, a second rail, and a first user input. In one example, the process displays a unit preparation map showing one of multiple story lines relating to object preparations in accordance with predefined parameters, user selections, and the first rail. Alternatively, the process displays prisoner camps showing one of multiple story lines relating to size and number of prisoner camps object in accordance with predefined parameters, user selections, and the first rail.

At block 1510, the process is capable of generating a set of visually moving tiles showing unit preparations in response to current images of the first rail and images of second rail in accordance with conversion of graphic elements into Xmap language elements. For example, the process can retrieve historical battle events corresponding to various conflicting nodes on the first rail. In one aspect, the process projects one of the visually moving tiles showing unit preparations based on the unit preparation request. Alternatively, the process is able to initiate Xmap for displaying an interactive map showing at least a portion of the first rail in response to one or more selected objects. In addition, the process is capable of restoring status of the first rail and the location of the first user on the first rail after the unit preparation request is completed.

### Battle Mode

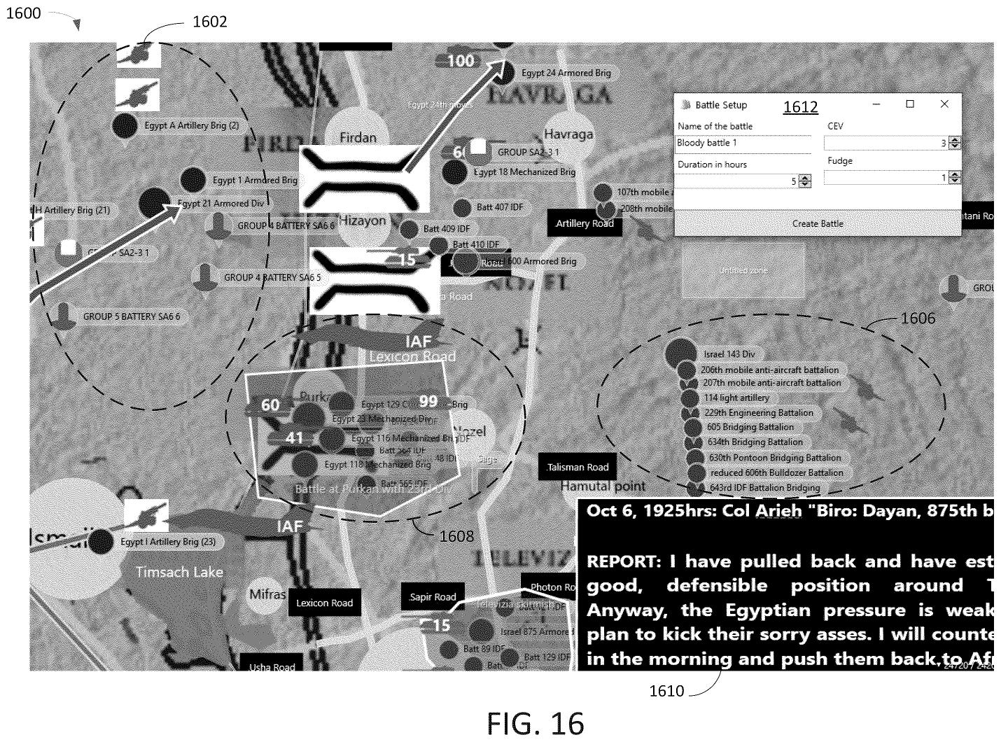

FIG. 16 is a block diagram 1600 illustrating a process of battle mode using Xmap facilitated by RCS in accordance with one or more embodiments of the present invention. Diagram 1600 includes a screen illustrating a battle ground containing a first group of troop 1602, a second group troop 1606, a first battle field 1608, and a drop down menu 1612. In one aspect, drop down menu 1612 provides viewing options for the player(s). It should be noted that the underlying concept of the exemplary embodiment(s) of the present invention would not change if one or more blocks (or symbols) were added to or removed from map 1600.

Xmap battle module, in one embodiment, is managed by the RCS system using Xmap for developing real-time visual illustrations for one or more game players. Xmap battle module facilitates and defines a battle (combat) based on the players. Battle drop down menu 1612 is used to allow a user or player to fill out one or more fields defining who fights whom and under what conditions, time duration, et cetera. To handle a battle or battles, Xmap manages the battle(s) in accordance with Xmap definitions entered by a user via drop down menu 1612. The Xmap definition includes, but not limited to, geographic area, parameters, and/or duration. The geographic area indicates the location of battle occurred. The parameters of the battle includes opposing forces 1602-1606, time, battle ground 1608, officers, and the like. The Xmap definition may further include battle outcome estimator such as Monte Carlo algorithm (“MCA”) for generating likelihood result of the battle. Xmap also includes a list showing which units are involved and content of the units involved based on unit data tables. All involved unit assets are summed up and fed into the battle algorithm. MCA calculates what is the chance of victory for each side, how long the battle lasts (in minutes or hours) and the losses of both sides in the battle. Depending on the applications, drop down battle menu 1612 can be located anywhere within the screen facilitated by Xmap. Also, Xmap is able to project a history event in a box 1610 showing historical battles.

Xmap, in one embodiment, is able to provide a battle mode process via the RCS system based on at least a portion of historical events. The battle mode process is capable of simulating a first rail containing multiple potential conflicting nodes emulating a first theater in accordance with at least a portion of recorded historical facts facilitated by the RCS system. After facilitating a first user to travel on the first rail approaching to a first node of the conflicting nodes, the process receives an inquiry of Xmap battle module for visual illustration of one or more possible battle storylines based on the first rail, a second rail, and a first user input. After generating multiple visual moving tiles of battle fields in response to current images of the first rail and images of second rail in accordance with conversion of graphic elements into Xmap language elements, a visual moving tile based on the inquiry of Xmap battle module is displayed. In one example, after retrieving historical battle events corresponding to various conflicting nodes on the first rail, the battle mode process provides imaging processing and photo-editing to creating visual moving tiles or screen images representing a visual display showing at least a portion of battles occurred on the first rail or the second rail.

### Skirmish and Prinsoner Mode

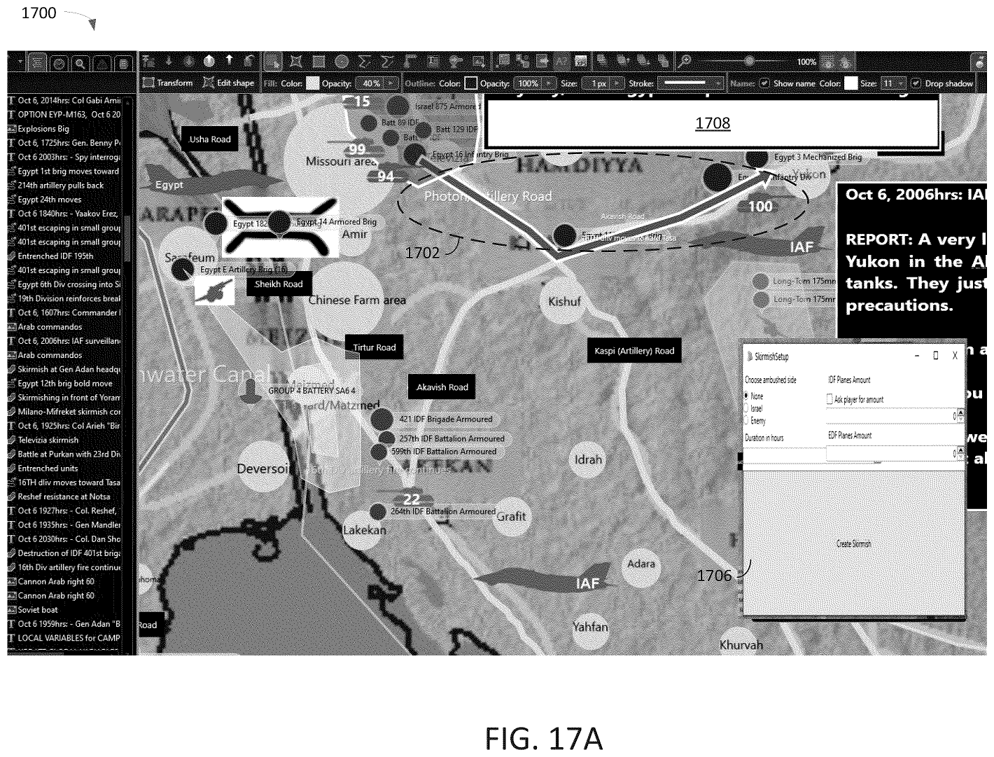

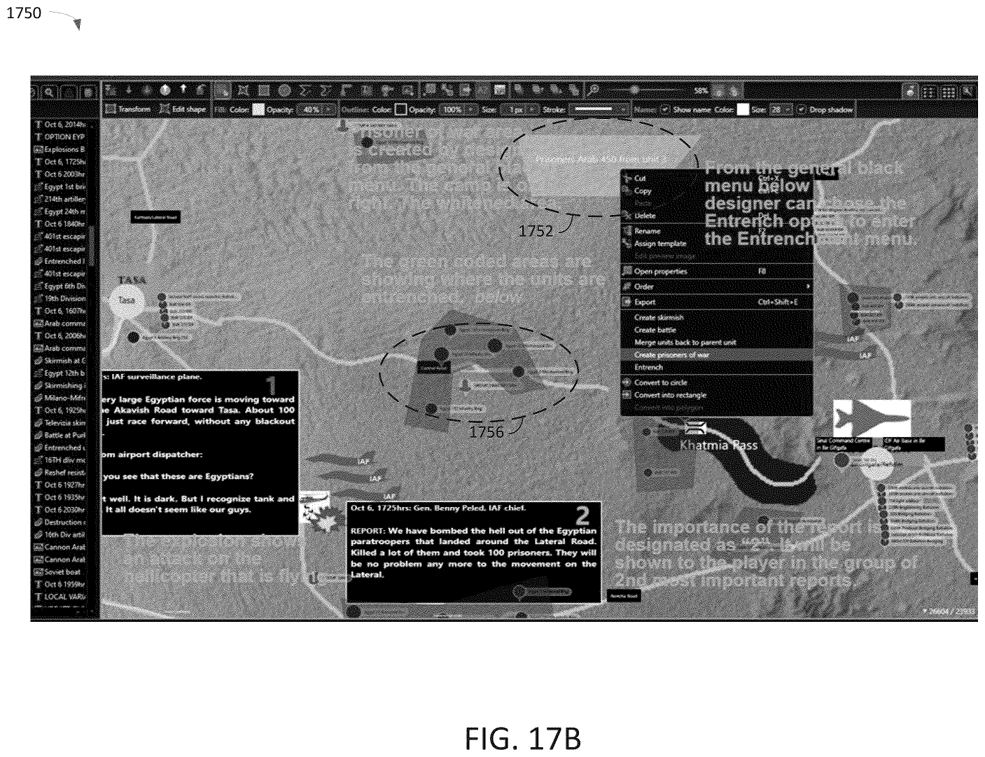

FIG. 17A is a block diagram 1700 illustrating a process of skirmish mode which is a feature of Xmap facilitated by RCS in accordance with one or more embodiments of the present invention. Diagram 1700 includes a screen illustrating a battle ground containing Egypt force, Israel force, a skirmish area 1702, dialogue box 1708, and menu 1706. In one aspect, skirmish area 1702 illustrates a path indicting several skirmishes. It should be noted that the underlying concept of the exemplary embodiment(s) of the present invention would not change if one or more blocks (or symbols) were added to or removed from map 1600.

The skirmish module, in one embodiment, is facilitated by Xmap using the RCS system for developing real-time visual illustrations of skirmish between two forces. The skirmish module defines fighting (combat) based on the players. Menu 1706 is used to allow a user or player to fill out one or more fields defining who fights whom and under what conditions, time duration, et cetera. To handle a skirmish or skirmishes, Xmap manages the skirmish(s) in accordance with Xmap definitions entered by a user via menu 1706. The definition includes, but not limited to, geographic area in which the battle occurs and parameters of the battle.

It should be noted that Skirmish, unlike battle, does not have a defined end combat outcome which specifies who is the winner and who is the loser. Skirmish area 1702 shows an arrow which indicates fighting path as well as moving forward after a successful skirmish. Xmap specifies the time length of a skirmish in a pop-up window such as dialogue box 1708 and defined combat loses during the skirmish. Skirmish, in one example, is just combat that is interrupted after some time, without any resolution.

Xmap, in one embodiment, is able to provide a process of skirmish via the RCS system based on at least a portion of historical events. The process is capable of simulating a first rail containing multiple potential conflicting nodes emulating a first theater in accordance with at least a portion of recorded historical facts facilitated by the RCS system. After facilitating a first user to travel on the first rail approaching to a first node of the conflicting nodes, the process receives an inquiry of skirmish selection for visual illustration of one or more possible skirmish storylines based on the first rail, a second rail, and a first user input. After generating multiple visual moving tiles of skirmish fields in response to current images of the first rail and images of second rail in accordance with conversion of graphic elements into Xmap language elements, a visual moving tile based on the inquiry of skirmish is displayed. In one example, after retrieving historical battle events corresponding to various conflicting nodes on the first rail, the process provides imaging processing and photo-editing to creating visual moving tiles or screen images representing a visual display showing at least a portion of skirmishes occurred on the first rail or the second rail.

### Prisoner

FIG. 17B is a block diagram 1750 illustrating an illustration of Xmap showing prisoners using RCS in accordance with one or more embodiments of the present invention. Diagram 1750 shows an area containing one or more prisoner camps 1752 and an area containing entrenched unit(s) 1756. Prisoner camp such as camp 1752 is a defined geographic area where the prisoners are kept. The menu with prison data table defines parameters related to the prisoner camp including the number of prisoners and their status. For example, a player can pick the data or parameters defining prison camp from the menu. The parameters include prison camp with running water, with barbed wired fence, inspections or visitations allowed, maximum prisoner population, guards, tortures, executions, food supply, and the like for running the prisoners.

### Entrenched Unit

Xmap, in one embodiment, includes a feature of visual illustration of entrenched unit via RCS showing entrenched force graphically on a screen or display. Entrenched unit, for example, is a fighting force situated in a geographic area. To display one or more entrenched unit(s), Xmap is configured to process and display visual illustrations of entrenched forces based on at least in part parameters. Parameters include time duration, size of unit, entrenched location, and the like. For example, a parameter may indicate the time needed to fully entrench (or dig in) a unit that has freshly arrived at a given location. Another parameter may describe how much the entrenched status of the military unit to enhance its ability to fight more effectively.

### Flying by Front Lines

Xmap, in one embodiment, includes a feature of visual illustration of flying by front lines via RCS showing front line battle status which is graphically displayed on a screen or a pop-up window. To facilitate a flying to front lines, Xmap creates certain places in a game where players can choose to fly to the front lines. At the front lines, a player or players, for example, can obtain or receive a detailed picture of how the war is unfolding and have more knowledge to make better decisions. If a player chooses to fly to the front lines, Xmap allows a player to see a static window of a helicopter cockpit which simulates a feeling of traveling to one of the front lines via a helicopter. After a few seconds of viewing the cockpit, the player can be placed in the headquarters of the front line for continuing combating opposing forces.

In one embodiment, when a player chooses to fly to the front lines in Sinai, the player may see a sandy desert and able to talk to real, historic characters that commanded by IDF in South. In operation, Xmap generates a starting point of flight to the “front lines”, a flight path is put on the map and a menu pops up to describe parameters of the flight. The pop-up menu includes a list of people that are flying, a starting time of the flight, duration of the flight, and a list of graphics visuals that the people will see out of the helicopter window.

### Protective Zone

Xmap, in one embodiment, includes a feature of protective zone visualizing a green zone on a map via RCS. For example, during a play of game progression, a dynamic definition of the SAM (surface-to-air missiles) anti-air defensive missile umbrella array is drawn on the map to denote a protected area. The protected area or protective zone, in one aspect, is an area that is fully protected from enemy missiles from air or ground attacks. The SAM missiles, for example, can be moved, stored, assembled, and/or destroyed. For example, when the SAM missiles are moved around, the boundaries of protected area automatically change and adjust in accordance with new location of SAM missiles. It should be noted that the degree to which the enemy aircraft performance is degraded inside these boundaries are indicated by modifying the enemy aircraft description variables. During operation, a special Xmap tile is created for illustrating graphics of protected area based on parameters and/or variables relating to the protective zone. The parameters and/or variables, in one example, includes maximum altitude in which the opposing aircraft can be hit, speed of firing the missiles, missile speed, SAM silos, number of SAM batteries, and the like.

### Both Sides Battle

Xmap, in one embodiment, includes a feature of visualizing both sides of battle on a map via RCS. Xmap is capable of representing or projecting combat status for both sides. For example, Xmap shows on a map projected on a screen representing a battle between two sides. For example, the opposing units are placed on the map and then straight lines connect the units that take part in the battle as opposed to the other units that do not participate in that battle. A method, in one aspect, provides a process of representation of which units participate in the battle that is taking place at the center of the hub of a map via color codes. In an alternative embodiment, Xmap provides a menu to players for specifying who is engaged in the battle with whom and who is idle.

### Real-Time Representation

Xmap, in one embodiment, includes a feature of real-time visualization on a map via RCS. Xmap provides live game map containing various objects, such as special vehicles, tanks, airplanes, drones, missiles, and/or other movable systems that might be non-operational even though they are in motion. For example, the objects, after arriving at their stationary destinations, need some preparation time to be activated. A movable missile truck, for example, is not able to fire its missiles while in transit. Once the movable missile truck arrives its destination, it may need a setup time for the missile to be operational. To handle real-time visualization, a set of parameters are used for facilitating the objects, also known as entities. The parameters include speed of travel, time needed to make the unit operational after the travel, degree of its inoperability (or partially inoperable), time to repair a damaged unit, time needed for maintenance of the unit, range of fuel needed to make unit operable, and the like. In one aspect, Xmap provides a definition menu to users for defining parameters such as movable vehicles.

### System

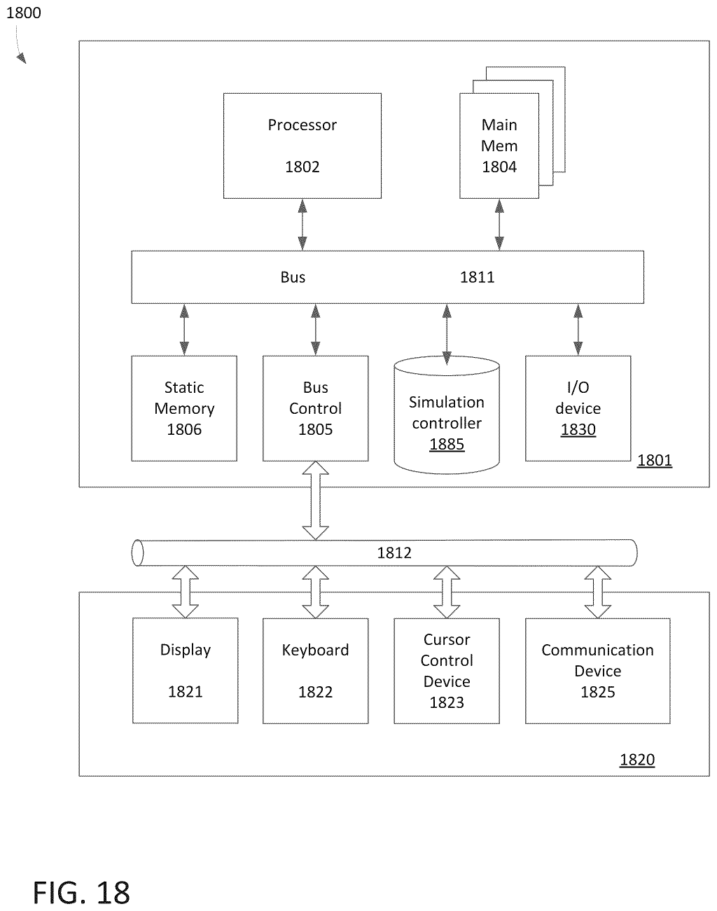

FIG. 18 is a block diagram 1800 illustrating a digital processing system capable of being configured to be the RCS system, database builder, and/or Xmap, in accordance with one or more embodiments of the present invention. Computer system 1800 can include a processing unit 1801, an interface bus 1812, and an input/output (“IO”) unit 1820. Processing unit 1801 includes a processor 1802, main memory 1804, system bus 1811, static memory device 1806, bus control unit 1805, I/O element 1830, and simulation controller 1885. It should be noted that the underlying concept of the exemplary embodiment(s) of the present invention would not change if one or more blocks (circuit or elements) were added to or removed from FIG. 18.

Bus 1811 is used to transmit information between various components and processor 1802 for data processing. Processor 1802 may be any of a wide variety of general-purpose processors, embedded processors, or microprocessors such as ARM® embedded processors, Intel® Core™ Duo, Core™ Quad, Xeon®, Pentium™ microprocessor, Motorola™ 68040, AMD® family processors, or Power PC™ microprocessor.

Main memory 1804, which may include multiple levels of cache memories, stores frequently used data and instructions. Main memory 1804 may be RAM (random access memory), MRAM (magnetic RAM), or flash memory. Static memory 1806 may be a ROM (read-only memory), which is coupled to bus 1811, for storing static information and/or instructions. Bus control unit 1805 is coupled to buses 1811-1812 and controls which component, such as main memory 1804 or processor 1802, can use the bus. Bus control unit 1805 manages the communications between bus 1811 and bus 1812. Mass storage memory or SSD which may be a magnetic disk, an optical disk, hard disk drive, floppy disk, CD-ROM, and/or flash memories are used for storing large amounts of data.

I/O unit 1820, in one embodiment, includes a display 1821, keyboard 1822, cursor control device 1823, and communication device 1825. Display device 1821 may be a liquid crystal device, cathode ray tube (“CRT”), touch-screen display, or other suitable display device. Display 1821 projects or displays images of a graphical planning board. Keyboard 1822 may be a conventional alphanumeric input device for communicating information between computer system 1800 and computer operator(s). Another type of user input device is cursor control device 1823, such as a conventional mouse, touch mouse, trackball, or other type of cursor for communicating information between system 1800 and user(s).

Communication device 1825 is coupled to bus 1811 for accessing information from remote computers or servers, such as server or other computers, through wide-area network. Communication device 1825 may include a modem or a network interface device, or other similar devices that facilitate communication between computer 1800 and the network. Computer system 1800 may be coupled to a number of servers via a network infrastructure.

Simulation controller 1885, in one aspect, is used to provide RCS supporting emulating electronic video games. Simulation controller 1885 can be hardware, software, or a combination of hardware and software for facilitating building database and rails. In one embodiment, simulator controller 1885 facilitates game played by multiple players and ranks players based on their scores.

While particular embodiments of the present invention have been shown and described, it will be obvious to those of ordinary skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A method for facilitating visual illustrations showing a sequence of events via a resource confined simulation (“RCS”) system based on at least a portion of historical events, the method comprising:
simulating a first rail containing multiple potential conflicting nodes emulating a first theater in accordance with at least a portion of recorded historical facts facilitated by the RCS system;
facilitating a first user to travel on the first rail approaching to a first node of the conflicting nodes;
receiving an inquiry of Xmap selection for visual illustration one or more possible story lines based on the first rail, a second rail, and a first user input;
generating a plurality of visual moving tiles in response to current images of the first rail and images of second rail in accordance with conversion of graphic elements into Xmap language elements; and
projecting one of the plurality of visual moving tiles based on the first user Xmap election.

2. The method of claim 1, wherein generating a plurality of visual moving tiles include retrieving historical battle events corresponding to various conflicting nodes on the first rail.

3. The method of claim 1, wherein receiving an inquiry of Xmap selection includes initiating a process of imaging processing and photo-editing to creating visual moving tiles or screen images representing a visual display showing at least a portion of elements distributed over a section of the first rail or the second rail.

4. The method of claim 1, wherein simulating a first rail includes identifying one or more rail splitters along the first rail coupling to a new rail.

5. The method of claim 1, wherein facilitating a first user to travel on the first rail includes identifying a location along the first rail in which the first user is currently on.

6. The method of claim 1, wherein receiving an inquiry of Xmap selection includes obtaining an Xmap command initiated by the first user requesting a display of an interactive map showing a portion of the first rail in response to one or more selected objects.

7. The method of claim 6, wherein obtaining an Xmap command includes displaying a unit preparation map showing one of multiple story lines relating to object preparations in accordance with predefined parameters, user selections, and the first rail.

8. The method of claim 6, wherein obtaining an Xmap command includes displaying prisoner camps showing one of multiple story lines relating to size and number of prisoner camps object in accordance with predefined parameters, user selections, and the first rail.

9. The method of claim 1, further comprising restoring status of the first rail and the location of the first user on the first rail after inquiry of Xmap is completed.

10. A method for facilitating visual illustrations showing a sequence of events via a resource confined simulation (“RCS”) system based on at least a portion of historical events, the method comprising:
simulating a first rail containing multiple potential conflicting nodes emulating a first theater in accordance with at least a portion of recorded historical facts facilitated by the RCS system;
facilitating a first user to travel on the first rail approaching to a first node of the conflicting nodes;
receiving a unit preparation request for illustrating one of multiple story lines relating to object preparations in accordance with predefined parameters, user selections, and the first rail;
initiating an Xmap for visual illustrations of unit preparation with one or more possible moving tiles based on the first rail, a second rail, and a first user input; and
generating a plurality of visual moving tiles showing unit preparations in response to current images of the first rail and images of second rail in accordance with conversion of graphic elements into Xmap language elements.

11. The method of claim 10, further comprising projecting one of the plurality of visual moving tiles showing unit preparations based on the unit preparation request.

12. The method of claim 10, further comprising initiating the Xmap for displaying an interactive map showing at least a portion of the first rail in response to one or more selected objects.

13. The method of claim 10, wherein generating a plurality of visual moving tiles include retrieving historical battle events corresponding to various conflicting nodes on the first rail.

14. The method of claim 10, wherein receiving a unit preparation request includes inactivating a process of imaging processing and photo-editing to creating visual moving tiles or screen images representing a visual display showing at least a portion of elements distributed over a section of the first rail or the second rail.

15. The method of claim 10, wherein initiating an Xmap includes displaying a unit preparation map showing one of multiple story lines relating to object preparations in accordance with predefined parameters, user selections, and the first rail.

16. The method of claim 10, wherein initiating an Xmap includes displaying prisoner camps showing one of multiple story lines relating to size and number of prisoner camps object in accordance with predefined parameters, user selections, and the first rail.

17. The method of claim 10, further comprising restoring status of the first rail and the location of the first user on the first rail after the unit preparation request is completed.

18. A method for facilitating visual illustrations showing a sequence of events via a resource confined simulation (“RCS”) system based on at least a portion of historical events, the method comprising:
simulating a first rail containing multiple potential conflicting nodes emulating a first theater in accordance with at least a portion of recorded historical facts facilitated by the RCS system;
facilitating a first user to travel on the first rail approaching to a first node of the conflicting nodes;
receiving an inquiry of Xmap battle module for visual illustration of one or more possible battle storylines based on the first rail, a second rail, and a first user input;
generating multiple visual moving tiles of battle fields in response to current images of the first rail and images of second rail in accordance with conversion of graphic elements into Xmap language elements; and
projecting one of the visual moving tiles based on the inquiry of Xmap battle module.

19. The method of claim 18, wherein generating multiple visual moving tiles includes retrieving historical battle events corresponding to various conflicting nodes on the first rail.

20. The method of claim 18, wherein receiving an inquiry of Xmap battle module includes initiating a process of imaging processing and photo-editing to creating visual moving tiles or screen images representing a visual display showing at least a portion of battles occurred on the first rail or the second rail.
